(19) United States
(12) Patent Application Publication
(10) Pub. No.: US 2026/0109248 A1
(43) Pub. Date: Apr. 23, 2026

(54) USER INTERFACE ELEMENT FOR DISPLAY OF OPERATIONAL STATUS OF A MULTI-DEVICE WIRELESS CHARGER

(71) Applicant: Honda Motor Co., Ltd., Tokyo (JP)

(72) Inventors: SMITHA PATINJARA PURAYIL, LEWIS CENTER, OH (US); ANDREW R. HOOVER, WEST LIBERTY, OH (US)

(21) Appl. No.: 18/794,955

(22) Filed: Oct. 22, 2024

(51) Int. Cl. B60L 53/30; B60L 53/68; H02J 50/60

(52) U.S. Cl. CPC B60L 53/305; B60L 53/68; H02J 50/60

(57) ABSTRACT

A first electronic device comprises circuitry that detects a connection status of a plurality of second electronic devices with a wireless charger and detects a charging status of the plurality of second electronic devices, based on the detected connection status. The circuitry detects a hardware failure associated with at least one of a plurality of charging systems of the multi-device wireless charger, based on the detected connection status and charging status. The circuitry determines an operational status of the multi-device wireless charger based on the connection status, the charging status, and the hardware failure. The circuitry renders a UI element indicative of the operational status on a display device associated with the first electronic device.

### BACKGROUND

Advancements in the fields of electronics and electrical technology have led to development of wireless charging of batteries of electronic devices. With an increasing focus on techniques for wireless charging of the batteries of the electronic devices, demand for the accurate detection of the SOC of batteries is increasing. In order to efficiently detect the SOC of batteries in an electronic device, a battery management system (BMS) may be used to provide security and longevity of the batteries. The BMS may continuously monitor and control of the SOC of the batteries and state of health (SOH) of the batteries. However, a major drawback of using the BMS is that those developed to date have not been able to efficiently detect the SOC and the SOH of the batteries, especially, in a scenario involving problems in charging due to issues in internal components of the batteries or the external components of the electronic devices.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

According to an embodiment of the disclosure, a first electronic device includes circuitry configured to detect a connection status of a plurality of second electronic devices with a multi-device wireless charger and to detect a charging status of the plurality of second electronic devices, based on the detected connection status. The multi-device wireless charger may be configured to charge multiple electronic devices concurrently using a plurality of charging systems. The connection status may be a status indicating wireless connection of the plurality of second electronic devices with the multi-device wireless charger. The circuitry may detect a hardware failure associated with at least one of a plurality of charging systems of the multi-device wireless charger, based on the detected connection status and the detected charging status. The circuitry may determine an operational status of the multi-device wireless charger, based on the detected connection status, the detected charging status, and the detected hardware failure. The circuitry may render, on a display device associated with the first electronic device, a user interface (UI) element indicative of the determined operational status of the multi-device wireless charger.

According to another embodiment of the disclosure, a vehicle includes an electronic control unit (ECU) configured to detect a multi-device wireless charger associated with a first electronic device. The multi-device wireless charger may be configured to charge multiple electronic devices concurrently using a plurality of charging systems, and the vehicle may include the first electronic device. The ECU may control detection of a connection status of a plurality of second electronic devices with the multi-device wireless charger, based on the detection of the multi-device wireless charger. The connection status may be a status indicating a wireless connection of the plurality of second electronic devices with the multi-device wireless charger. The ECU may control detection of a charging status of the plurality of second electronic devices, based on the detection of the connection status. The ECU may control detection of a hardware failure associated with at least one of the plurality of charging systems of the multi-device wireless charger, based on the detected connection status and charging status. The ECU may control determination of an operational status of the multi-device wireless charger based on the detection of the connection status, charging status, and hardware failure. The ECU may control rendering, on a display device, an UI element indicative of the operational status of the multi-device wireless charger.

According to another embodiment of the disclosure, a method includes detection of a connection status of a plurality of second electronic devices with a multi-device wireless charger associated with a first electronic device. The multi-device wireless charger may be configured to charge multiple electronic devices concurrently using a plurality of charging systems. The connection status may be a status indicating a wireless connection of the plurality of second electronic devices with the multi-device wireless charger. The method may include detection of a charging status of the plurality of second electronic devices, based on the detected connection status. The method may include detection of a hardware failure associated with at least one of the plurality of charging systems of the multi-device wireless charger, based on the detected connection status and the detected charging status. The method may include determination of an operational status of the multi-device wireless charger based on the detected connection status, the detected charging status, and the detected hardware failure. The method may include rendering, on the display device associated with the first electronic device, a UI element indicative of the determined operational status of the multi-device wireless charger.

### BRIEF DESCRIPTION OF THE DRAWINGS

FIG. 1 is a block diagram that illustrates an exemplary network environment for user interface (UI) element-based display of an operational status of a multi-device wireless charger, in accordance with an embodiment of the disclosure.

FIG. 2 is a block diagram that illustrates an exemplary first electronic device of FIG. 1, in accordance with an embodiment of the disclosure.

FIG. 3 is a block diagram that illustrates an exemplary vehicle of FIG. 1, in accordance with an embodiment of the disclosure.

FIG. 4 is a diagram that illustrates an execution pipeline for UI element-based display of the operational status of the multi-device wireless charger, in accordance with an embodiment of the disclosure.

FIG. 5A is a block diagram that illustrates an exemplary scenario for UI element-based display of the operational status of the multi-device wireless charger installed in the vehicle, in accordance with a first embodiment of the disclosure.

FIG. 5B is a block diagram that illustrates an exemplary scenario for UI element-based display of the operational status of the multi-device wireless charger installed in the vehicle, in accordance with a second embodiment of the disclosure.

FIG. 5C is a block diagram that illustrates an exemplary scenario for UI element-based display of the operational status of the multi-device wireless charger installed in the vehicle, in accordance with a third embodiment of the disclosure.

FIG. 5D is a block diagram that illustrates an exemplary scenario for UI element-based display of the operational status of the multi-device wireless charger installed in the vehicle, in accordance with a fourth embodiment of the disclosure.

FIG. 5E is a block diagram that illustrates an exemplary scenario for UI element-based display of the operational status of the multi-device wireless charger installed in the vehicle, in accordance with a fifth embodiment of the disclosure.

FIG. 5F is a block diagram that illustrates an exemplary scenario for UI element-based display of the operational status of the multi-device wireless charger installed in the vehicle, in accordance with a sixth embodiment of the disclosure.

FIG. 6 is a table that illustrates different UI elements displayed corresponding to different scenarios of the operational status of the multi-device wireless charger, in accordance with an embodiment of the disclosure.

FIG. 7 is a flowchart that illustrates exemplary operations of a method for UI element-based display of the operational status of the multi-device wireless charger, in accordance with an embodiment of the disclosure.

FIG. 8 is a flowchart that illustrates exemplary operations of a method for UI element-based display of the operational status of the multi-device wireless charger installed in a vehicle, in accordance with an embodiment of the disclosure.

The foregoing summary, as well as the following detailed description of the present disclosure, is better understood when read in conjunction with the appended drawings. For the purpose of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

The following described implementations may be found in an electronic device and a method including a user interface (UI) element that is provided for display of an operational status of a multi-device wireless charger. A first electronic device may detect a connection status of a plurality of second electronic devices with a multi-device wireless charger. The multi-device wireless charger may charge multiple electronic devices concurrently using a plurality of charging systems. The connection status may be a status indicating a wireless connection of the plurality of second electronic devices with the multi-device wireless charger. The first electronic device may detect a charging status of the plurality of second electronic devices, based on the detected connection status. The first electronic device may detect a hardware failure associated with at least one of the plurality of charging systems of the multi-device wireless charger, based on the detected connection status and the detected charging status. The first electronic device may determine an operational status of the multi-device wireless charger based on the detected connection status, the detected charging status, and the detected hardware failure. The first electronic device may also render, on a display device associated with the first electronic device, a UI element indicative of the determined operational status of the multi-device wireless charger.

Furthermore, an electronic control unit (ECU) of a vehicle may detect the multi-device wireless charger associated with the first electronic device. Thereafter, the ECU may control detection of the connection status of the plurality of second electronic devices with the multi-device wireless charger, based on the detection of the multi-device wireless charger. The ECU may control detection of the charging status of the plurality of second electronic devices, based on the control of the detection of the connection status. The ECU may control detection of the hardware failure associated with the at least one of the plurality of charging systems of the multi-device wireless charger, based on the control of the detection of the connection status and the charging status. The ECU may control determination of the operational status of the multi-device wireless charger, based on the control of the detection of the connection status, the charging status, and the hardware failure. The ECU may also control rendering on the display device, the UI element indicative of the operational status of the multi-device wireless charger.

The UI element may indicate the operational status of the multi-device wireless charger as a distinct icon, based on a connection status, a charging status, a hardware fault/failure status, and/or a foreign object status, related to at least two electronic devices that may be connected to the multi-device wireless charger. The operational status of the multi-device wireless charger may be useful in effectively presenting charging information of multiple electronic devices concurrently to a user. For example, the UI element may be an informative icon for display in an instrumentation cluster of the vehicle or through a dashboard of a mobile application of the user.

Reference will now be made in detail to specific aspects or features, examples of which are illustrated in the accompanying drawings. Wherever possible, corresponding or similar reference numbers will be used throughout the drawings to refer to the same or corresponding parts.

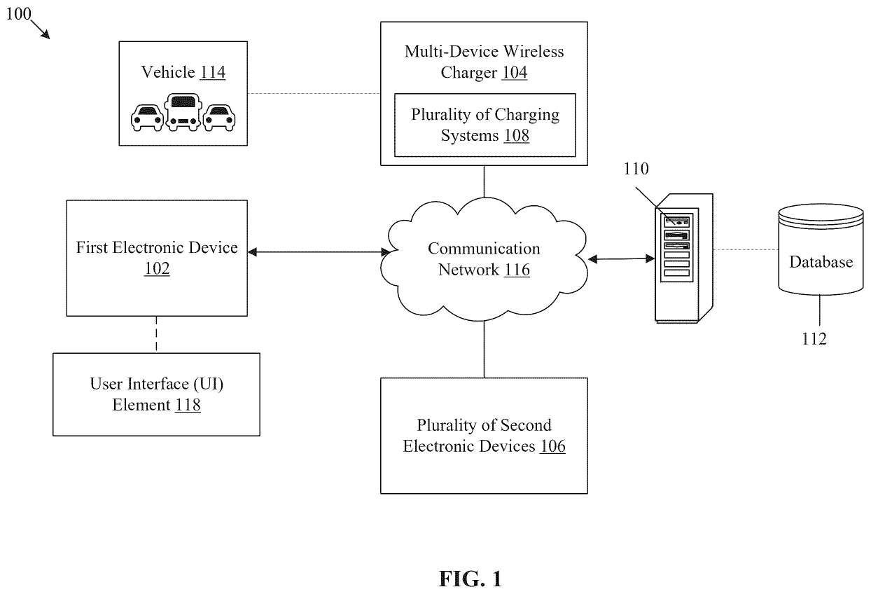

FIG. 1 is a block diagram that illustrates an exemplary network environment for user interface (UI) element-based display of an operational status of a multi-device wireless charger, in accordance with an embodiment of the disclosure. With reference to FIG. 1, there is shown a network environment 100 that may include a first electronic device 102, a multi-device wireless charger 104, a plurality of second electronic devices 106, a server 110, a database 112, a vehicle 114, and a communication network 116. The multi-device wireless charger 104 comprises a plurality of charging systems 108, which may include two or more than two charging systems. There is also shown a user interface (UI) element 118 associated with the first electronic device 102.

The first electronic device 102, the multi-device wireless charger 104, the plurality of second electronic devices 106, the server 110 and the vehicle 114 may be communicatively coupled to one another via the communication network 116. In some embodiments, the database 112 may be connected to the communication network 116. Alternatively, or additionally, the database 112 may be accessible through the server 110. Further, the database 112 may include a set of connection status data, charging status data, and hardware failure data.

The first electronic device 102 may include suitable logic, control circuitry, interfaces, and/or code that may be configured to detect a connection status of each of a plurality of second electronic devices (e.g., the plurality of second electronic devices 106) with a wireless charger (e.g., the multi-device wireless charger 104). The connection status may be a status indicating the wireless connection of the plurality of second electronic devices 106 with the multi-device wireless charger 104. The first electronic device 102 may detect a charging status of each of the plurality of second electronic devices 106, based on the detected connection status. The first electronic device 102 may also detect a hardware failure associated with at least one of the plurality of charging systems 108 of the multi-device wireless charger 104, based on the detected connection status and charging status. Further, the first electronic device 102 may determine an operational status of the multi-device wireless charger 104 based on the detected connection status, charging status, and hardware failure. Moreover, the first electronic device 102 may render, on a display device associated with the first electronic device 102, a UI element (e.g., the UI element 118) indicative of the determined operational status of the multi-device wireless charger 104. Examples of the first electronic device 102 may include, but are not limited to, a computing device, a smartphone, a cellular phone, a mobile phone, a user wearable device, a computer work-station, a consumer electronic (CE) device, an electric control unit, a navigation system, an infotainment system, a vehicle remote controller device, or any computing device associated with the vehicle 114. In an embodiment, the first electronic device 102 may be associated with at least one of a manufacturer, a retailer, a dealer, a vendor, a service provider, an infrastructure provider, or a user associated with the vehicle 114.

The multi-device wireless charger 104 may include suitable logic, control circuitry, interfaces, and/or code that may be configured to charge multiple (e.g., two or more) electronic devices concurrently. In some embodiments, the multi-device wireless charger 104 may be associated with the first electronic device 102. The multi-device wireless charger 104 may be configured to detect the connection status of the plurality of second electronic devices 106 and to detect the charging status of the plurality of second electronic devices 106. The multi-device wireless charger 104 may also be configured to detect the hardware failure associated with the at least one of the plurality of charging systems 108 of the multi-device wireless charger 104. The operational status of the multi-device wireless charger 104 may be determined based on the detected connection status, charging status, and hardware failure. The multi-device wireless charger 104 may also be configured to control the rendering of the UI element 118, which may be indicative of the determined operational status of the multi-device wireless charger 104, on the display device associated with the first electronic device 102. Examples of the multi-device wireless charger 104 may correspond to, but are not limited to, a radio-based wireless charger, an electric coupling-based wireless charger, an electromagnetic induction-based wireless charger, a near-field wireless charger, or a magnetic resonance-based wireless charger.

Each of the plurality of second electronic devices 106 may be configured to be wirelessly connected with the multi-device wireless charger 104. Examples of the plurality of second electronic devices 106 may include, but are not limited to, a computing device, a smartphone, a cellular phone, a mobile phone, a user wearable device, a mainframe machine, a server, a computer work-station, a consumer electronic (CE) device, a vehicle remote controller device, or any computing device that may be capable to be wirelessly connect with the multi-device wireless charger 104 and start charging.

The plurality of charging systems 108 may be wireless charging systems provided by the multi-device wireless charger 104. The plurality of charging systems 108 may detect whether there is a hardware failure in one or more of the plurality of charging systems 108. For example, the hardware failure may correspond to at least one of a thermistor failure, a fan failure, an internal temperature failure, a Direct Current (DC)-DC failure, or a power supply failure. The hardware failure may be detected based on the connection status and the charging status of the plurality of charging systems 108. The plurality of charging systems 108 may transmit information indicative of the detection of the hardware failure to the first electronic device 102. The plurality of charging systems 108 may further detect whether any foreign object (e.g., an object other than an electronic device) is present on a surface or in a vicinity or proximity of the multi-device wireless charger 104. For example, the foreign object may be a piece of wire, cloth, plastic, or any other material. Further, the foreign object may include items like metal coins, keys, credit cards, metal phone cases, or any other object that may interfere with magnetic field of the multi-device wireless charger 104. The plurality of charging systems 108 may include, but are not limited to, a capacitive wireless charging system, a permanent magnetic gear wireless charging system, an inductive wireless charging system, or any other wireless charging system capable of charging an electronic device.

The server 110 may include suitable logic, control circuitry, and interfaces, and/or code that may be configured to receive the connection status of the plurality of second electronic devices 106 with the multi-device wireless charger 104. The server 110 may also receive the charging status of the plurality of second electronic devices 106, based on the detected connection status. The server 110 may further receive the hardware failure associated with the at least one of the plurality of charging systems 108 of the multi-device wireless charger 104, based on the detected connection status and charging status. The connection status, the charging status, and the hardware failure may be received from the first electronic device 102 and/or the multi-device wireless charger 104. The server 110 may determine the operational status of the multi-device wireless charger 104 based on the received connection status, charging status, and hardware failure. The server 110 may also transmit information indicative of the operational status of the multi-device wireless charger 104 to the first electronic device 102. The server 110 may be further configured to control the rendering of the UI element 118, which may be indicative of the determined operational status of the multi-device wireless charger 104, on the display device associated with the first electronic device 102.

The server 110 may be implemented as a cloud server and may execute operations through web applications, cloud applications, HTTP requests, repository operations, file transfer, and the like. Other example implementations of the server 110 may include, but are not limited to, a database server, a file server, a web server, a media server, an application server, a mainframe server, or a cloud computing server. In at least one embodiment, the server 110 may be implemented as a plurality of distributed cloud-based resources by use of several technologies that are known to those ordinarily skilled in the art. Furthermore, the scope of the disclosure is not limited to the implementation of the server 110 and the first electronic device 102 (and/or the multi-device wireless charger 104) as separate entities. In certain embodiments, the functionalities of the server 110 can be incorporated in its entirety or at least partially in the first electronic device 102 (and/or the multi-device wireless charger 104) without a departure from the scope of the disclosure.

The database 112 may include suitable logic, interfaces, and/or code that may be configured to store information related to the connection status of the plurality of second electronic devices 106 with the multi-device wireless charger 104, instructions to control the charging status of the plurality of second electronic devices 106, connection status data, charging status data, and hardware failure data. The database 112 may be derived from data off a relational or non-relational database, or a set of comma-separated values (csv) files in conventional or big-data storage.

The database 112 may be stored or cached on a device, such as a server (e.g., the server 110) or an electronic device (e.g., the first electronic device 102). The device storing the database 112 may be configured to receive a query for vehicle identification information and/or the data associated with the plurality of second electronic devices 106 from the server 110 and/or the first electronic device 102. In response, the device of the database 112 may be configured to retrieve and provide the queried vehicle identification information or and/or the data associated with the plurality of second electronic devices 106 to the server 110 and/or the first electronic device 102 based on the received query. In some embodiments, the database 112 may be hosted on a plurality of servers stored at the same or different locations. The operations of the database 112 may be executed using hardware including a processor, a microprocessor (e.g., to perform or control performance of one or more operations), a field-programmable gate array (FPGA), or an application-specific integrated circuit (ASIC). In some other instances, the database 112 may be implemented using software.

The vehicle 114 may include suitable logic, control circuitry, interfaces, and/or code that may be configured to detect the multi-device wireless charger 104. In some embodiments, the vehicle 114 may include the first electronic device 102, and the multi-device wireless charger 104 may be associated with the first electronic device 102. The vehicle 114 may control the detection of the connection status of the plurality of second electronic devices 106 with the multi-device wireless charger 104, based on the detection of the multi-device wireless charger 104. The vehicle 114 may also control the detection of the charging status of the plurality of second electronic devices 106, based on the detection of the connection status. Further, the vehicle 114 may control the detection of the hardware failure associated with at least one of the plurality of charging systems 108 of the multi-device wireless charger 104, based on the detection of the connection status and the charging status. The vehicle 114 may also control the determination of the operational status of the multi-device wireless charger 104 based on the detection of the connection status, the charging status, and the hardware failure. Furthermore, the vehicle 114 may control the rendering, on the display device, of the UI element 118 indicative of the operational status of the multi-device wireless charger 104.

The vehicle 114 may be a non-autonomous vehicle, a semi-autonomous vehicle, or a fully autonomous vehicle. The term “vehicle” may include, for example, cars, trucks, vans, minivans, SUVs, motorcycles, scooters, boats, personal watercraft, aircraft, etc. In some embodiments, the vehicle 114 may be a system through which a rider may travel from a start point to a destination point. Examples of the vehicle 114 may include, but are not limited to, a two-wheeler vehicle, a three-wheeler vehicle, a four-wheeler vehicle, a hybrid vehicle, or a vehicle with autonomous drive capability that uses one or more distinct renewable or non-renewable power sources. A vehicle that uses renewable or non-renewable power sources may include a fossil fuel-based vehicle, an electric propulsion-based vehicle, a hydrogen fuel-based vehicle, a solar-powered vehicle, and/or a vehicle powered by other forms of alternative energy sources. For example, the four-wheeler vehicle may include, but is not limited to, an electric car, an internal combustion engine (ICE)-based car, a fuel-cell based car, a solar powered-car, or a hybrid car. The description of other types of the vehicle 114 has been omitted from the disclosure for the sake of brevity. The vehicle 114 may be registered to a corresponding owner based on vehicle identification information associated with the corresponding vehicle.

The communication network 116 may include a communication medium through which the first electronic device 102, the multi-device wireless charger 104, the plurality of second electronic devices 106, the server 110 (and in some cases the database 112), and the vehicle 114 may communicate with each other. The communication network 116 may be one of a wired connection or a wireless connection. Examples of the communication network 116 may include, but are not limited to, the Internet, a cloud network, Cellular or Wireless Mobile Network (such as Long-Term Evolution and 5G New Radio), satellite network (e.g., a network of a set of low earth orbit satellites), a Wireless Fidelity (Wi-Fi) network, a Personal Area Network (PAN), a Local Area Network (LAN), or a Metropolitan Area Network (MAN). Various devices in the network environment 100 may be configured to connect to the communication network 116 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

The UI element 118 may be indicative of the operational status of the multi-device wireless charger 104. In one aspect, the operational status of the multi-device wireless charger 104 may be a first status corresponding to a steady state charging associated with each connected device of the plurality of second electronic devices 106 that is charging. The UI element 118 may include a first icon based on the operational status being the first status. In another aspect, the operational status may be a second status corresponding to the steady state charging associated with one connected device (e.g., a first device) of the plurality of second electronic devices 106 and the detection of the hardware failure in charging of another connected device (e.g., a second device) of the plurality of second electronic devices 106. The UI element 118 may include a second icon based on the operational status being the second status. In another aspect, the operational status may be a third status corresponding to the detection of the hardware failure in charging systems of each device of the plurality of second electronic devices 106. The UI element 118 may include a third icon based on the operational status being the third status.

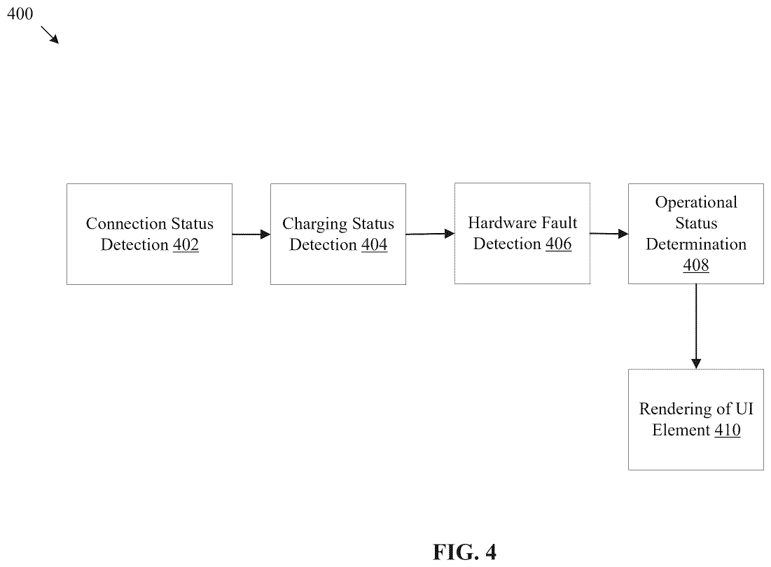

In operation, the first electronic device 102 may be configured to detect the connection status of each of the plurality of second electronic devices 106 with the multi-device wireless charger 104. In an embodiment, the multi-device wireless charger 104 may be configured to charge two or more connected devices of the plurality of second electronic devices 106 concurrently using the plurality of charging systems. Details related to the detection of the connection status of the plurality of second electronic devices 106 are further provided, for example, in FIG. 4 (at 402).

The first electronic device 102 may be configured to detect the charging status of the plurality of second electronic devices 106, based on the detected connection status. Details related to the detection of the charging status of the plurality of second electronic devices 106 are further provided, for example, in FIG. 4 (at 404).

The first electronic device 102 may detect the hardware failure associated with at least one charging system of the plurality of charging systems 108 of the multi-device wireless charger 104, based on the detected connection status and charging status. Details related to the detection of the hardware fault or failure associated with the at least one charging system are further provided, for example, in FIG. 4 (at 406).

The first electronic device 102 may determine the operational status of the multi-device wireless charger 104 based on the detected connection status, charging status, and hardware failure. The operational status may be, for example, a first status corresponding to a steady state charging associated with each connected device of the plurality of second electronic devices 106 that is charging; a second status corresponding to a steady state charging associated with a first connected device of the plurality of second electronic devices 106 and the detection of the hardware failure in charging of a second connected device of the plurality of second electronic devices 106; or a third status corresponding to the detection of the hardware failure in charging of each connected device of the plurality of second electronic devices 106. Details related to the operational status determination are further provided, for example, in FIG. 4 (at 408).

The first electronic device 102 may render, on the display device associated with the first electronic device 102, the UI element 118 indicative of the operational status of the multi-device wireless charger 104. Herein, upon rendering of the UI element, at least one icon may be displayed indicating the operational status of the multi-device wireless charger 104. Details related to the rendering of the UI element 118 are further provided, for example, in FIG. 4 (at 410).

Additionally, or alternatively, the first electronic device 102 may detect a foreign object associated with at least one of the plurality of charging systems 108 of the multi-device wireless charger 104, based on the detected connection status and charging status. The foreign object is an object other than the electronic device. For example, foreign objects may correspond to items, which interfere with the magnetic field of a wireless charger, such as metal coins, keys, credit cards, metal phone cases, or any other object that may interfere with the magnetic field of the multi-device wireless charger 104. The first electronic device 102 may also render, on a display device associated with the first electronic device 102, a notification panel including a set of icons associated with at least one of the detected connection status, the detected charging status, the detected hardware failure, or the detected foreign object.

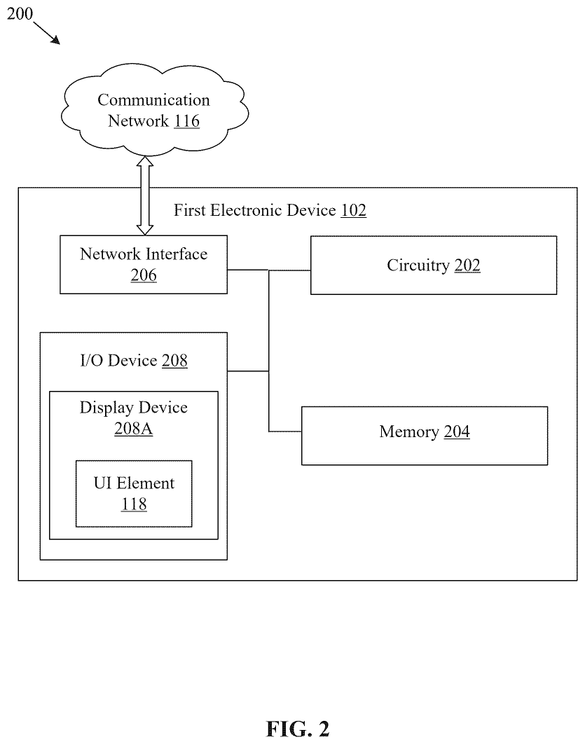

FIG. 2 is a block diagram that illustrates an exemplary first electronic device of FIG. 1, in accordance with an embodiment of the disclosure. FIG. 2 is explained in conjunction with elements from FIG. 1. With reference to FIG. 2, there is shown a block diagram 200 of the first electronic device 102 that may include circuitry 202, memory 204, a network interface 206, and an input/output (I/O) device 208. The input/output (I/O) device 208 may include a display device 208A. Although it is shown that the first electronic device 102 includes the circuitry 202, the memory 204, the network interface 206, and the input/output (I/O) device 208; however, the disclosure may not be so limiting, and the first electronic device 102 may include less or more components to perform the same or other functions. Details of the other functions or components have been omitted from the disclosure for the sake of brevity. The functions or operations executed by the first electronic device 102, as described in FIG. 1, may be performed by the circuitry 202. Operations executed by the circuitry 202 are described in detail, for example, in FIG. 4.

The circuitry 202 may include suitable logic, control circuitry, and interfaces that may be configured to execute one or more program instructions associated with different operations to be executed by the first electronic device 102. For example, some of the operations may include, connection status detection, charging status detection, hardware failure detection, foreign object detection, operational status determination, and rendering of the UI element. The circuitry 202 may include one or more specialized processing units, which may be implemented as a separate processor. In an embodiment, the one or more specialized processing units may be implemented as an integrated processor or a cluster of processors that perform the functions of the one or more specialized processing units, collectively. The circuitry 202 may be implemented based on a number of processor technologies known in the art. Examples of implementations of the circuitry 202 may be an X86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other control circuits.

The memory 204 may include suitable logic, control circuitry, and interfaces that may be configured to store the one or more program instructions to be executed by the circuitry 202. The memory 204 may be configured to store the connection status data, the charging status data, the hardware failure data, and the vehicle identification information associated with the vehicle 114. Examples of implementation of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The network interface 206 may include suitable logic, control circuitry, and interfaces that may be configured to facilitate communication between the first electronic device 102, the multi-device wireless charger 104, the plurality of second electronic devices 106, the server 110, the database 112 and the vehicle 114 via the communication network 116. The network interface 206 may be implemented by use of various known technologies to support wired or wireless communication of the first electronic device 102 with the communication network 116. The network interface 206 may include, but may be not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer control circuitry. The network interface 206 may be configured to communicate via wireless communication with networks, such as the Internet, an Intranet or a wireless network, such as a cellular telephone network, a wireless local area network (LAN), and a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), 5^{th} Generation New Radio (5G NR), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VoIP), light fidelity (Li-Fi), Worldwide Interoperability for Microwave Access (Wi-MAX), a protocol for email, instant messaging, and a Short Message Service (SMS).

The I/O device 208 may include suitable logic, control circuitry, and interfaces that may be configured to receive an input from the user and provide an output based on the received input. The I/O device 208, which may include various input and output devices, may be configured to communicate with the first electronic device 102 and/or the server 110. Examples of the I/O device 208 may include, but are not limited to, a touch screen, a keyboard, a mouse, a joystick, a microphone, a display device (e.g., the display device 208A), a haptic device, and a speaker.

The display device 208A may include suitable logic, control circuitry, and interfaces that may be configured to display the detected connection status of the plurality of second electronic devices 106 with the multi-device wireless charger 104, the detected charging status of the plurality of second electronic devices 106, the detected hardware failure associated with the at least one of the plurality of charging systems 108, the determined operational status of the multi-device wireless charger 104, and the rendered UI element. The display device 208A may be a touch screen, such as a resistive touch screen, a capacitive touch screen, or a thermal touch screen, which may enable the user to provide a user-input via the display device 208A. The display device 208A may be realized through several known technologies such as, but not limited to, at least one of a Liquid Crystal Display (LCD) display, a Light Emitting Diode (LED) display, a plasma display, or an Organic LED (OLED) display technology, or other display devices. In accordance with an embodiment, the display device 208A may refer to a display screen of a head mounted device (HMD), a smart-glass device, a see-through display, a projection-based display, an electro-chromic display, or a transparent display.

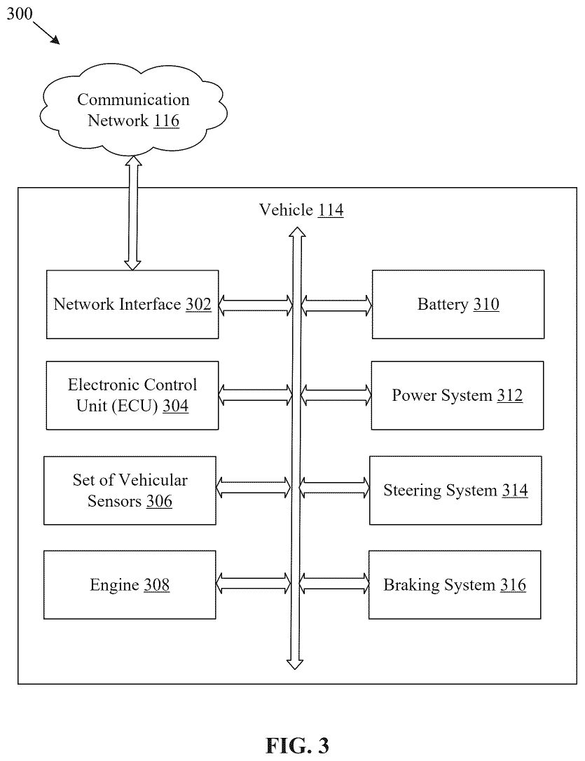

FIG. 3 is a block diagram that illustrates an exemplary vehicle of FIG. 1, in accordance with an embodiment of the disclosure. FIG. 3 is explained in conjunction with elements from FIG. 1 and FIG. 2. With reference to FIG. 3, there is shown a block diagram 300 of the vehicle 114 that may include a network interface 302, an electronic control unit (ECU) 304, a set of vehicular sensors 306, an engine 308, a battery 310, a power system 312, a steering system 314, and a braking system 316. Although it is shown that the vehicle 114 includes the network interface 302, the electronic control unit 304, the set of vehicular sensors 306, the engine 308, the battery 310, the power system 312, the steering system 314, and the braking system 316; however, the disclosure may not be so limiting, and the vehicle 114 may include less or more components to perform the same or other functions of the vehicle 114. Details of the other functions or components have been omitted from the disclosure for the sake of brevity.

The network interface 302 may include suitable logic, control circuitry, and interfaces that may be configured to facilitate communication between the vehicle 114, the first electronic device 102, the multi-device wireless charger 104, the plurality of second electronic devices 106, and the server 110 via the communication network 116. The network interface 302 may be implemented by use of various known technologies to support wired or wireless communication of the vehicle 114 with the communication network 116. The network interface 302 may include, but may be not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer control circuitry. The network interface 302 may be configured to communicate via wireless communication with networks, such as the Internet, an Intranet or a wireless network, such as a cellular telephone network, a wireless local area network (LAN), and a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), 5^{th} Generation New Radio (5G NR), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VoIP), light fidelity (Li-Fi), Worldwide Interoperability for Microwave Access (Wi-MAX), a protocol for email, instant messaging, and a Short Message Service (SMS).

The electronic control unit (ECU) 304 may include suitable logic, control circuitry, interfaces, and/or code that may be configured to activate or deactivate the set of vehicular sensors 306. The electronic control unit 304 may be a specialized electronic control circuitry that may include an ECU processor to control different functions, such as, but not limited to, engine operations, communication operations, and data acquisition of the vehicle 114. In an embodiment, the electronic control unit 304 may be a microprocessor. Other examples of the electronic control unit 304 may include, but are not limited to, a vehicle control system, an in-vehicle infotainment (IVI) system, an in-car entertainment (ICE) system, an automotive Head-up Display (HUD), an automotive dashboard, an embedded device, a human-machine interface (HMI), a computer workstation, a handheld computer, a smartphone, a cellular/mobile phone, a portable consumer electronic (CE) device, a server, and other computing devices. The electronic control unit 304 may be included or integrated in the vehicle 114.

In an embodiment, the electronic control unit 304 may be control circuitry that may be configured to detect the multi-device wireless charger 104 associated with the first electronic device 102. The control circuitry may control detection of the connection status of the plurality of second electronic devices 106 with the multi-device wireless charger 104, based on the detection of the multi-device wireless charger 104. The control circuitry may control detection of the charging status of the plurality of second electronic devices 106, based on the control of the detection of the connection status. The control circuitry may control detection of the hardware failure associated with the at least one of the plurality of charging systems 108 of the multi-device wireless charger 104, based on the control of the detection of the connection status and the charging status. The control circuitry may control determination of the operational status of the multi-device wireless charger 104 based on the control of the detection of the connection status, the charging status, and the hardware failure. The control circuitry may control rendering, on the display device 208A associated with the first electronic device 102, the UI element 118 indicative of the operational status of the multi-device wireless charger 104.

The set of vehicular sensors 306 may include a speedometer, an accelerometer, a location sensor, a tachometer, a weather sensor, an imaging sensor, a pressure sensor, a temperature sensor, a level sensor, a shock absorber, and the like. The speedometer may measure an instantaneous or an average speed of the vehicle 114. The accelerometer may measure an instantaneous or an average acceleration of the vehicle 114. The location sensor may determine a location of the vehicle 114. The tachometer may determine a speed in rotations per minute of the engine 308 of the vehicle 114. The weather sensor may determine a weather of the location of the vehicle 114. The imaging sensor may capture images of a region around the vehicle 114. The pressure sensor may determine a pressure of fluids (for example, engine oil, transmission oil, and hydraulic oil) of the vehicle 114. The level sensor may determine a level of fluids of the vehicle 114. The temperature sensor may determine a temperature of a region around the vehicle 114. The temperature sensor may also determine an internal temperature of the engine 308.

The engine 308 may be configured to provide power to the vehicle 114. The engine 308 may be an internal combustion engine with may include operations, for example, fuel injection, compression, ignition, or emission to power and drive the vehicle 114. The engine 308 may include various parts, for example, but are not limited to, a crankshaft, a cylinder, a spark plug, a piston, camshaft, a valve, combustion chamber, etc. In some embodiments, the engine 308 may include a motor in case of an electric vehicle. The engine 308 may be two-stroke or four-stroke internal combustion engines and may include either one, two, three, four, or six cylinders. Examples of the engine 308 may include, but are not limited to, an inline engine (e.g., single cylinder, parallel twin, inline-triple, inline-four, inline-six), a V layout engine (e.g., V-twin engine, a V4 engine, a V8 engine), a flat (boxer) engine (e.g., flat-two, flat-four, flat-six), a lawn mower engine, a snow blower engine, a motorcycle engine, or other vehicle engines known in the art. A description of various parts of the engine 308 has been omitted from the disclosure for the sake of brevity.

The battery 310 may be a source of electric power for one or more electric circuits or loads (not shown). For example, the battery 310 may be a source of electrical power to the control circuitry of the vehicle 114, network interface 302, the electronic control unit 304, the engine 308, the power system 312, the steering system 314, and the braking system 316. The battery 310 may be a rechargeable battery. The battery 310 may be the source of electrical power to start the engine 308 of the vehicle 114. In some embodiments, the battery 310 may correspond to a battery pack, which may have a plurality of clusters of batteries, which may be surrounded by a suitable coolant and a charge controller (not shown). Examples of the battery 310 may include, but are not limited to, a lead acid battery, a nickel cadmium battery, a nickel-metal hydride battery, a lithium-ion battery, and other rechargeable batteries.

The power system 312 may include suitable logic, control circuitry, interfaces, and/or code that may be configured to control electric power which may be output to various electric circuits and loads of the vehicle 114. The power system 312 may include a battery (not shown) to provide the electric power to perform various electrical operations of the vehicle 114. The power system 312 may provide the electric power for functioning of different components (such as the electronic control unit 304, the steering system 314, and the set of vehicular sensors 306) of the vehicle 114. The power system 312 may be configured to receive control signals from a processor to control the electronic control unit 304, the steering system 314, and the set of vehicular sensors 306 of the vehicle 114. The power system 312 may be configured to control the charging and the discharging of the battery 310 and an auxiliary battery based on the received control signals. The power system 312 may be configured to control the transfer of the electric energy between the power system 312, the steering system 314, and the set of vehicular sensors 306 of the vehicle 114. Examples of the power system 312 may include, but are not limited to, an electric charge/discharge controller, a charge regulator, a battery regulator, a battery management system, an electric circuit breaker, a power electronic drive control system, an Application-Specific Integrated Circuit (ASIC) processor, and/or other energy-control hardware processors.

The steering system 314 may receive one or more control commands from the user. The steering system 314 may include a steering wheel or handlebar and/or an electric motor (provided for a power-assisted steering) that may be used by a driver to control movement of the vehicle 114 in manual mode or a semi-autonomous mode. In accordance with an embodiment, the movement or steering of the vehicle 114 may be automatically controlled when the vehicle 114 is in autonomous mode. Examples of the steering system 314 may include, but are not limited to, a power-assisted steering system, a vacuum/hydraulic-based steering system, an electro-hydraulic power-assisted system (EHPAS), or a “steer-by-wire”system, or an autonomous steering system.

The braking system 316 may be used to stop or slow down the vehicle 114 by application of resistive forces, such as electromagnetic and/or frictional forces. The braking system 316 may receive a command from a powertrain control system under the control of control circuitry when the vehicle 114 is in an autonomous mode or a semi-autonomous mode. In accordance with an embodiment, the braking system 316 may receive a command from the control circuitry when the control circuitry preemptively detects intent of the user to perform a specific task which requires the user to apply brakes.

FIG. 4 is a illustrates an execution pipeline for UI element-based display of the operational status of the multi-device wireless charger, in accordance with an embodiment of the disclosure. FIG. 4 is explained in conjunction with elements from FIGS. 1-3. With reference to FIG. 4, there is shown an execution pipeline 400 of exemplary operations from 402 to 410 that may be executed, for example, by the circuitry 202 of the first electronic device 102.

At 402, an operation of connection status detection may be executed. In an embodiment, the circuitry 202 may be configured to detect the connection status of multiple devices of the plurality of second electronic devices 106 with the multi-device wireless charger 104. The multi-device wireless charger 104 may be configured to charge the multiple devices concurrently using the plurality of charging systems 108. It may be appreciated that the connection status data may be detected upon the connection of each of the plurality of second electronic devices 106 with the multi-device wireless charger 104, and the connection status data may be stored in the database 112. In an embodiment, when a second electronic device (of the plurality of second electronic devices 106) is, for example, aligned with, positioned on a surface of, or placed in proximity to the multi-device wireless charger 104, the first electronic device 102 may detect a connection between the second electronic device and the multi-device wireless charger 104. Based on the detected connection, the first electronic device 102 may detect the connection status of each of the plurality of second electronic devices 106 with the multi-device wireless charger 104.

At 404, an operation of charging status detection may be executed. In an embodiment, the circuitry 202 may be configured to detect the charging status of the plurality of second electronic devices 106, based on the detected connection status with the multi-wireless charger 104. It may be appreciated that the charging status data corresponding to the plurality of second electronic devices 106 may be detected, based on the detected connection status data, and the charging status data may be stored in the database 112. The charging status data may include a state of charge (SOC) of the battery which provides information associated with an amount of charge that may be available in the battery at a time instant. The provided information may be relative to a capacity of the battery, for example, the SOC may be represented in terms of a percentage of charge left in the battery. In one aspect, a predefined SOC of the battery may be a minimum percentage of charge that may be needed to be present in a battery of the multi-device wireless charger 104 (and/or the vehicle 114) so that a set of critical operations associated with the multi-device wireless charger 104 (and/or the vehicle 114) may be executed. In an embodiment, when a second electronic device (of the plurality of second electronic devices 106) is, for example, aligned with, positioned on a surface of, or placed in proximity to the multi-device wireless charger 104, the first electronic device 102 may detect a connection and a flow of current between the second electronic device and the multi-device wireless charger 104. Based on the detected connection and detected flow of current, the first electronic device 102 may detect the charging status of the plurality of second electronic devices 106 with the multi-device wireless charger 104.

At 406, an operation of hardware fault or failure detection may be executed. In an embodiment, the circuitry 202 may be configured to detect a hardware fault or failure associated with at least one the plurality of charging systems 108 of the multi-device wireless charger 104, based on the detected connection status and charging status. It may be appreciated that the hardware failure data associated with the at least one of the plurality of charging systems 108 may be detected, based on the detected connection status and charging status, and the hardware failure data may be stored in the database 112. In an embodiment, the detected hardware failure may correspond to at least one of, but not limited to, a thermistor failure, a fan failure, an internal temperature failure, a Direct Current (DC)-DC failure, or a power supply failure.

At 408, an operation of operational status determination may be executed. In an embodiment, the circuitry 202 may be configured to determine the operational status of the multi-device wireless charger 104 based on the detected connection status, charging status, and hardware failure. In some embodiments, the circuitry 202 may retrieve information about different scenarios of the connection status, the charging status, and the hardware failure from a lookup table. The lookup table may be, for example, either stored on a memory associated with the ECU 304, the memory 204 of the first electronic device 102, or the database 112. In one aspect, the operational status may be a first status corresponding to a steady state charging associated with each electronic device of the plurality of second electronic devices 106 that is charging. In another aspect, the operational status may be a second status corresponding to a steady state charging associated with a first device of the plurality of second electronic devices 106 and the detection of the hardware failure in charging of a second device of the plurality of second electronic devices 106. In another aspect, the operational status may be a third status corresponding to the detection of the hardware failure in the charging systems of each electronic device of the plurality of second electronic devices 106.

In an embodiment, the circuitry 202 may be further configured to detect a foreign object associated with at least one of the plurality of charging systems 108 of the multi-device wireless charger 104, based on the detected connection status and charging status. The foreign object is an object other than the electronic device. The foreign object may include items that may interfere with the magnetic field of the multi-device wireless charger, such as metal coins, keys, credit cards, metal phone cases, or any other object that interferes with the magnetic field of the multi-device wireless charger. Further, the foreign object may be detected based on at least one of, but not limited to, a partial power transfer to a thermistor or a partial power supply to the plurality of charging systems 108 of the multi-device wireless charger 104.

In another aspect, the operational status may be a fourth status corresponding to the steady state charging associated with a first device of the plurality of second electronic devices 106 and the detection of the foreign object in the charging system associated with a second device of the plurality of second electronic devices 106. In another aspect, the operational status may be a fifth status corresponding to the detection of the foreign object associated with each charging system of the plurality of charging systems 108 of the multi-device wireless charger 104. In another aspect, the operational status may be a sixth status corresponding to the detection of the foreign object in the charging system associated with the first device of the plurality of second electronic devices 106 and the detection of the hardware failure in the charging system of the second device of the plurality of second electronic devices 106.

In an embodiment, the circuitry 202 may also determine a priority associated with the sixth status corresponding to the detection of the foreign object in the charging system associated with the first device of the plurality of second electronic devices 106 and the detection of the hardware failure in the charging system of the second device of the plurality of second electronic devices 106. For example, in a case when the priority of the detected hardware failure is determined to be higher than the priority of the detected foreign object, the circuitry 202 may control the UI element 118 to indicate the detection of the hardware failure as a primary issue with the charging of electronic devices by the multi-device wireless charger 104.

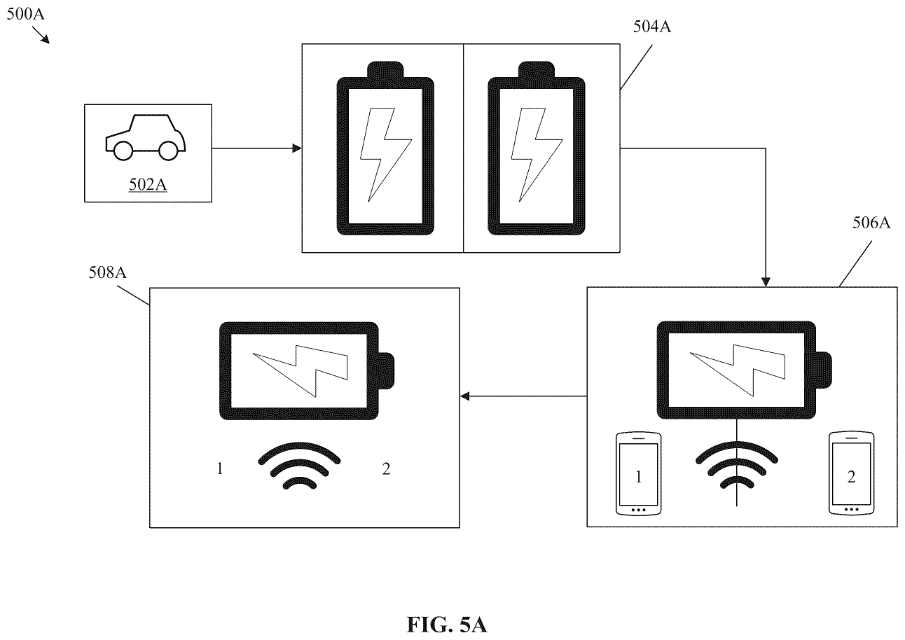

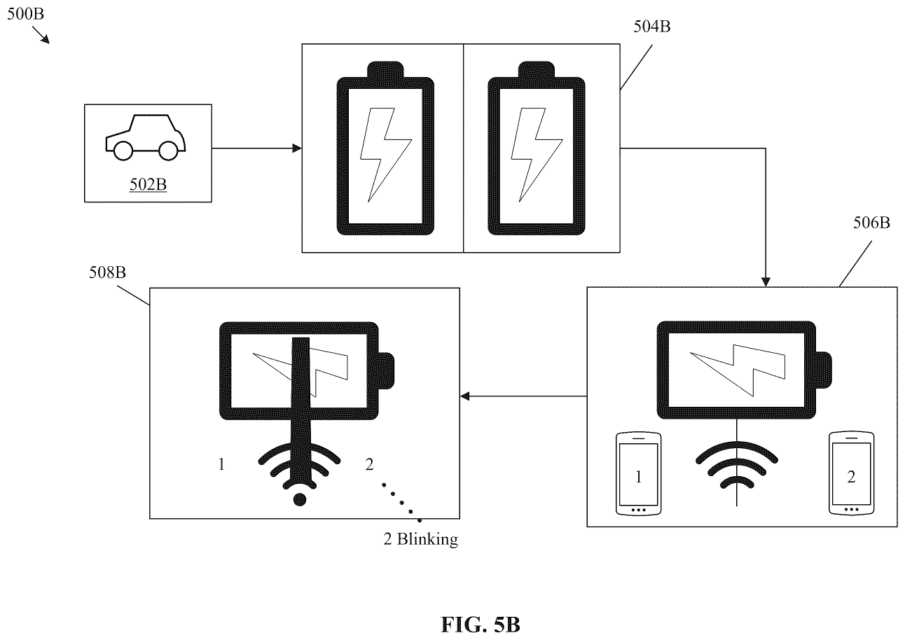

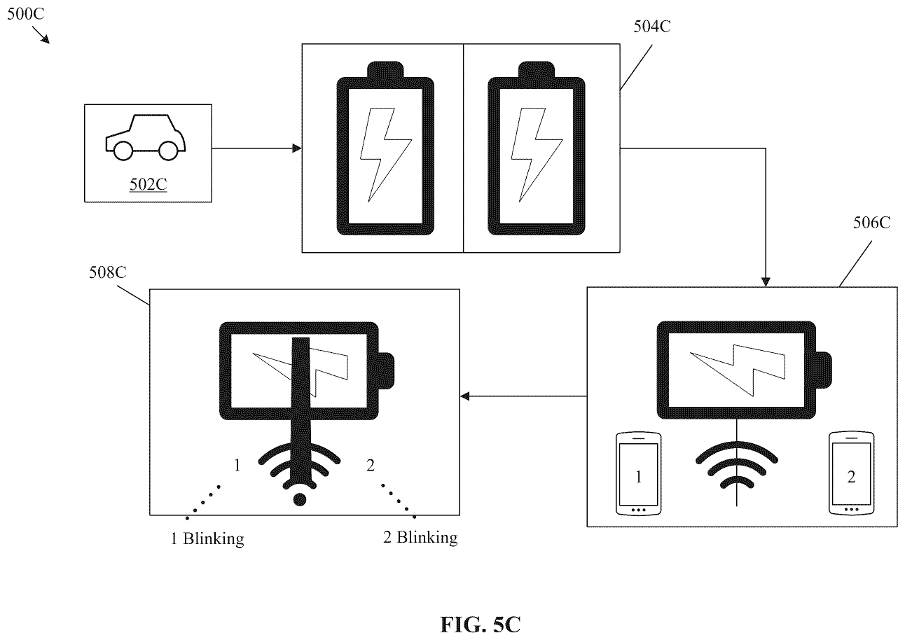

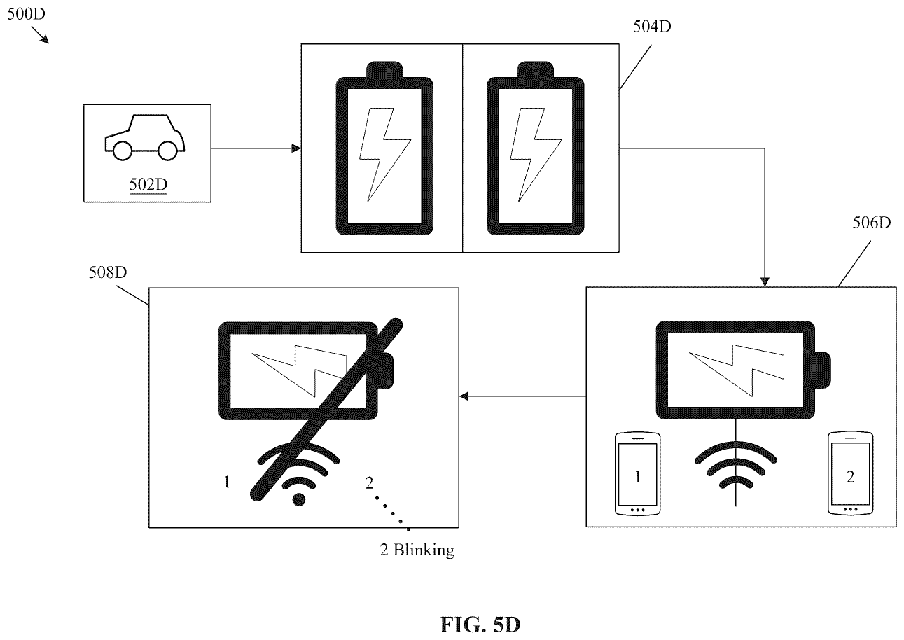

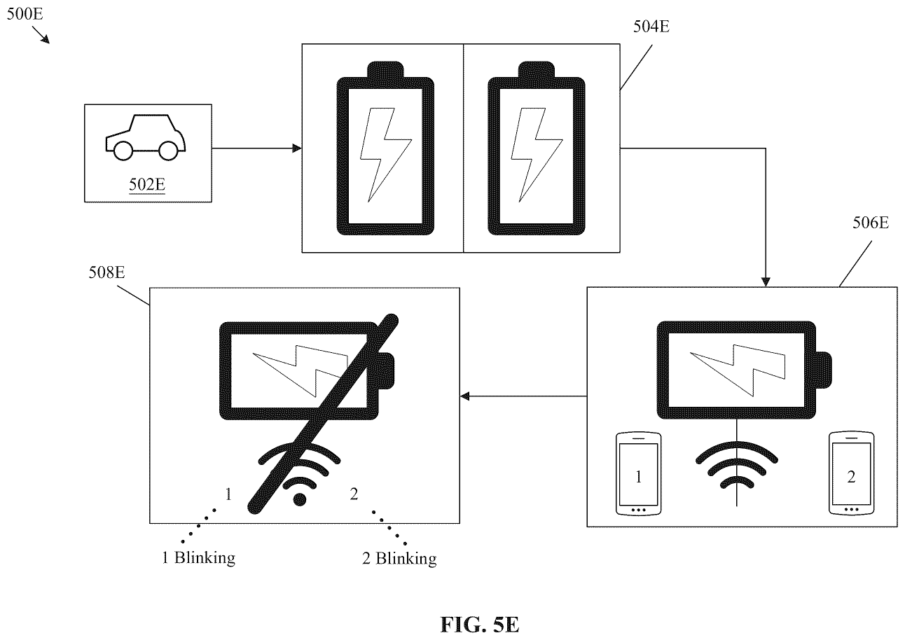

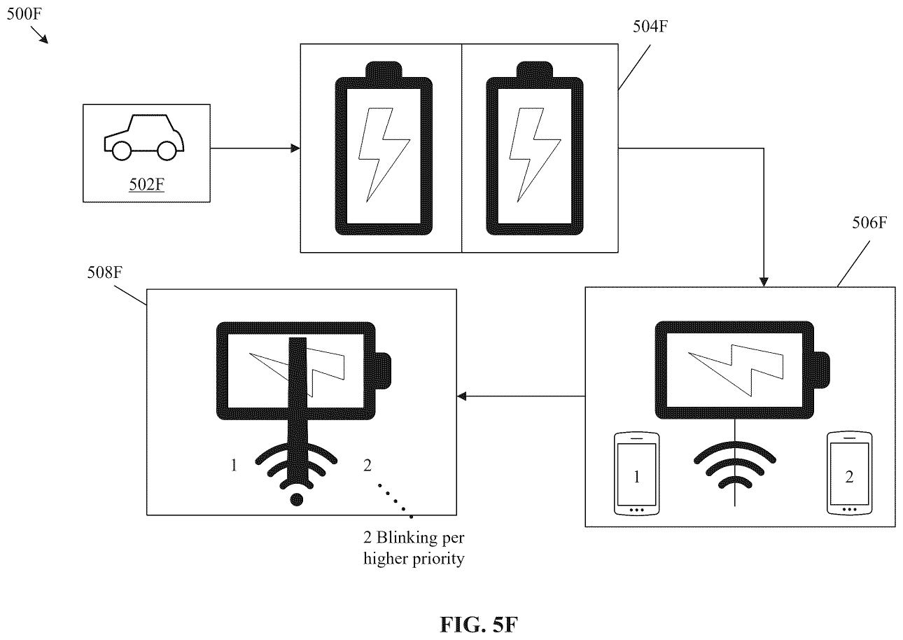

At 410, an operation of rendering of a UI element may be executed. In an embodiment, the circuitry 202 may be configured to render, on the display device 208A associated with the first electronic device 102, the UI element 118 indicative of the determined operational status of the multi-device wireless charger 104. The UI element 118 may include an icon corresponding to each operational status of the multi-device wireless charger 104. Herein, the UI element 118 may include a first icon based on the operational status being the first status; a second icon based on the operational status being the second status; a third icon based on the operational status being the third status; a fourth icon corresponding to the operational status being the fourth status; a fifth icon corresponding to the operational status being the fifth status; and a sixth icon corresponding to the operational status being the sixth status. Exemplary scenarios related to the icons that indicate the operational status of the multi-device wireless charger are further provided, for example, in FIGS. 5A-5F.

It may be noted that the vehicle 114 may include the circuitry 202 (and/or the ECU 304), which may detect the multi-device wireless charger 104 associated with the first electronic device 102. The vehicle 114 may also include the first electronic device 102. For example, the ECU 304 may detect a connection status of the multi-device wireless charger 104 with an electrical socket of a dashboard of the vehicle 114. Based on a detection that the multi-device wireless charger 104 is connected with the electrical socket, the ECU 304 may detect the multi-device wireless charger 104.

The circuitry 202 (and/or the ECU 304) may control detection of the connection status of the plurality of second electronic devices 106 with the multi-device wireless charger 104, based on the detection of the multi-device wireless charger 104. The circuitry 202 (and/or the ECU 304) may control detection of the charging status of the plurality of second electronic devices 106, based on the detection of the connection status. The circuitry 202 (and/or the ECU 304) may control detection of the hardware failure associated with the at least one of the plurality of charging systems 108 of the multi-device wireless charger 104, based on the detection of the connection status and the charging status. The circuitry 202 (and/or the ECU 304) may control determination of the operational status of the multi-device wireless charger 104 based on the detection of the connection status, the charging status, and the hardware failure. The circuitry 202 (and/or the ECU 304) may control rendering of the UI element 118, which may indicate of the operational status of the multi-device wireless charger 104, on the display device 208A associated with the first electronic device 102 (and/or a display device of the vehicle 114).

Furthermore, the UI element 118 may indicate the operational status as a distinct icon based on a connection status, a charging status, a hardware fault/failure detection status, or a foreign object detection status related to at least two electronic devices that may be connected to the multi-device wireless charger 104. The operational status may be useful in effectively presenting charging information of multiple electronic devices concurrently to a user. For example, the UI element 118 may be an informative icon for display in an instrumentation cluster of the vehicle or through a dashboard of a mobile application of the user.

FIG. 5A is a block diagram that illustrates an exemplary scenario for UI element-based display of the operational status of the multi-device wireless charger installed in the vehicle, in accordance with a first embodiment of the disclosure. FIG. 5A is explained in conjunction with elements from FIGS. 1-4. With reference to FIG. 5A, there is shown an exemplary scenario 500A for the UI element-based display of the operational status of the multi-device wireless charger that includes a vehicle 502A, a detected connection status 504A, a detected charging status 506A, and a notification panel 508A including a UI element, such as an icon. It should be noted that the exemplary scenario 500A of FIG. 5A is for exemplary purposes and should not be construed to limit the scope of the disclosure.

The vehicle 502A may include suitable logic, control circuitry, interfaces, and/or code, for example, the circuitry 202 and/or the ECU 304, that may be configured to detect the multi-device wireless charger 104 associated with the first electronic device 102. The vehicle 502A may be configured to detect the connection status of each of the plurality of second electronic devices 106 with the multi-device wireless charger 104, which is configured to charge the multiple electronic devices concurrently. The connection status may be a status indicating wireless connection of each of the plurality of second electronic devices with the multi-device wireless charger 104. The vehicle 502A may also detect the charging status of each of the plurality of second electronic devices 106, based on the detected connection status. The vehicle 502A may also detect the hardware failure associated with at least one of the plurality of charging systems 108 of the multi-device wireless charger 104, based on the detected connection status and charging status. Further, the vehicle 502A may determine the operational status of the multi-device wireless charger 104 based on the detected connection status, charging status, and hardware failure. Moreover, the vehicle 502A may control the rendering, on the display device 208A associated with the first electronic device 102, of the UI element 118 indicative of the operational status of the multi-device wireless charger 104.

In an example, the detected connection status 504A may indicate the connection status data that may be detected upon the wireless connection of the plurality of second electronic devices 106 with the multi-device wireless charger 104. The connection status data may be stored in the database 112. The detected connection status 504A may indicate whether the plurality of second electronic devices 106 are properly connected with the multi-device wireless charger 104. For example, herein, the user interface (UI) of the first electronic device 102 may display symbols of at least two electronic devices, which indicate successful wireless connection of a first device and a second device of the plurality of second electronic devices 106 with the multi-device wireless charger 104.

Further, in an example, the detected charging status 506A may indicate the charging status data that may be detected based on the connection status of the plurality of second electronic devices 106 with the multi-device wireless charger 104. The charging status data may be stored in the database 112. For example, herein, the charging status may indicate status of charging associated with the first device and the second device of the plurality of second electronic devices 106 (e.g., designated by numerals “1” and “2”), upon the wireless connection of the first device and the second device with the multi-device wireless charger 104. Further, the detected charging status 506A may indicate, but is not limited to, a state of charge (SOC) of the battery which provides information associated with an amount of charge that may be available in the battery at a time instant. The provided information may be relative to a capacity of the battery, for example, the SOC may be represented in terms of a percentage of charge left in the battery. In one aspect, a predefined SOC of the battery may be a minimum percentage of charge that may be needed to be present in a battery of the vehicle 114 so that a set of critical operations associated with the vehicle 114 may be executed.

Additionally, a hardware failure associated with at least one charging system of the plurality of charging systems 108 of the multi-device wireless charger 104 may be detected, based on the detected connection status and charging status. Based on the detected connection status, charging status, and hardware failure, the operational status of the multi-device wireless charger 104 may be determined. Thereafter, based on the determined operational status of the multi-device wireless charger 104, the UI element 118 may be rendered on the display device 208A associated with the first electronic device 102. In an example, the notification panel 508A may be configured to be displayed on the display device 208A of the first electronic device 102. The notification panel 508A may be configured to render a set of icons associated with at least one of the detected connection status, charging status, or hardware failure.

For example, herein, the notification panel 508A may display the UI element in form of a first icon associated with each connected second electronic device that is charging when the charging systems of the multi-device wireless charger 104 are operating normally. The first icon may indicate the determined operational status as a first status corresponding to the steady state charging associated with each connected device of the plurality of second electronic devices 106 that is charging. For example, the first icon may indicate steady state charging associated with the first device and the second device of the plurality of second electronic devices 106 (e.g., designated by numerals “1” and “2”) when each of the charging systems 108 of the multi-device wireless charger 104 are operating normally and both the first device and the second device are charging. In other aspects, the first icon may indicate steady state charging associated with only one of the first device or second device when only one device is charging.

FIG. 5B is a block diagram that illustrates an exemplary scenario for UI element-based display of the operational status of the multi-device wireless charger installed in the vehicle, in accordance with a second embodiment of the disclosure. FIG. 5B is explained in conjunction with elements from FIGS. 1-4 and 5A. With reference to FIG. 5B, there is shown an exemplary scenario 500B for the UI element-based display of the operational status of the multi-device wireless charger that includes a vehicle 502B, detected connection status 504B, detected charging status 506B, and a notification panel 508B. It should be noted that the exemplary scenario 500B of FIG. 5B is for exemplary purposes and should not be construed to limit the scope of the disclosure.

The vehicle 502B may be similar to the vehicle 502A of FIG. 5A and the vehicle 114 of FIG. 1. The detected connection status 504B may be similar to the detected connection status 504A of FIG. 5A, and the detected charging status 506B may be similar to the detected charging status of 506A. Hence, details of the vehicle 502B, detected connection status 504B, and detected charging status 506B are omitted herein for the sake of brevity.

In an example, a hardware failure associated with at least one charging system of the plurality of charging systems 108 of the multi-device wireless charger 104 may be detected, based on the detected connection status and the detected charging status. Based on the detected connection status, the detected charging status, and the detected hardware failure, the operational status of the multi-device wireless charger 104 may be determined. Thereafter, based on the determined operational status of the multi-device wireless charger 104, the UI element 118 may be rendered on the display device 208A associated with the first electronic device 102. In an example, the notification panel 508B may be configured to be displayed on the display device 208A of the first electronic device 102. The notification panel 508B may be configured to render a set of icons associated with at least one of the detected connection status, charging status, or hardware failure.

For example, herein, the notification panel 508B may display the UI element in form of a second icon associated with the detected hardware failure of at least one of the charging systems of the multi-device wireless charger 104. The second icon may indicate the determined operational status as a second status corresponding to the steady state charging associated with one connected device (e.g., the first device) of the plurality of second electronic devices 106 and the detection of the hardware failure in charging of another connected device (e.g., the second device) of the plurality of second electronic devices 106. In an example, the second icon may indicate a hardware failure detection symbol, such as an exclamation mark in the center of the second icon, and blinking with respect to the detected hardware failure in the charging system associated with the second device designated by the numeral “2” blinking (or the numeral “2” may change font type, color, etc.).

The hardware failure detection symbol (e.g., the exclamation mark) denotes detection of the hardware failure in at least one of the charging systems of the multi-device wireless charger. The charging system associated with the second device blinks (or may change font type, color, etc.) to notify the user of the location of the detected hardware failure, while the charging system associated with the first device does not change due to operating normally. Additionally, the user may be notified that the hardware failure is present in the charging system associated with the second device. For example, based on the user interaction with the second icon (e.g., user tapping of the second icon through the I/O device 208) a notification center may be displayed for the user. The notification center may include a message of the hardware failure detected in the charging system of the second device.

FIG. 5C is a block diagram that illustrates an exemplary scenario for UI element-based display of the operational status of the multi-device wireless charger installed in the vehicle, in accordance with a third embodiment of the disclosure. FIG. 5C is explained in conjunction with elements from FIGS. 1-4 and 5A-5B. With reference to FIG. 5C, there is shown an exemplary scenario 500C for the UI element-based display of the operational status of the multi-device wireless charger that includes a vehicle 502C, detected connection status 504C, detected charging status 506C, and a notification panel 508C. It should be noted that the exemplary scenario 500C of FIG. 5C is for exemplary purposes and should not be construed to limit the scope of the disclosure

The vehicle 502C may be similar to the vehicle 502A of FIG. 5A and the vehicle 114 of FIG. 1. The detected connection status 504C may be similar to the detected connection status 504A of FIG. 5A, and the detected charging status 506C may be similar to the detected charging status of 506A. Hence, details of the vehicle 502C, detected connection status 504C, and detected charging status of 506C are omitted herein for the sake of brevity.

In an example, a hardware failure associated with at least one charging system of the plurality of charging systems 108 of the multi-device wireless charger 104 may be detected, based on the detected connection status and the detected charging status. Based on the detected connection status, the detected charging status, and the detected hardware failure, the operational status of the multi-device wireless charger 104 may be determined. Thereafter, based on the determined operational status of the multi-device wireless charger 104, the UI element 118 may be rendered on the display device. In an example, the notification panel 508C may be configured to render a set of icons associated with at least one of the detected connection status, charging status, or hardware failure.

For example, herein, the notification panel 508C may display the UI element in form of a third icon associated with detected hardware failure of each of the charging systems of the multi-device wireless charger 104. The third icon may indicate the determined operational status as a third status corresponding to the detection of the hardware failure in the charging associated with the first device and the second device of the plurality of second electronic devices 106. In an example, the third icon may indicate the hardware failure detection symbol (e.g., the exclamation mark) and blinking with respect to the detected hardware failure in the charging systems associated with the first device and the second device which may be designated by the numeral “1” blinking and the numeral “2” blinking (or the numerals “1” and “2” may change font type, color, etc.). Additionally, the user may be notified that the hardware failure is present in the charging systems of both the first device and the second device. For example, based on the user interaction with the third icon (e.g., user tapping of the third icon through the I/O device 208), a notification center may be displayed for the user. The notification center may include a message of the hardware failure detected in the charging systems of both the first device and the second device.

FIG. 5D is a block diagram that illustrates an exemplary scenario for UI element-based display of the operational status of the multi-device wireless charger installed in the vehicle, in accordance with a fourth embodiment of the disclosure. FIG. 5D is explained in conjunction with elements from FIGS. 1-4 and 5A-5C. With reference to FIG. 5D, there is shown an exemplary scenario 500D for the UI element-based display of the operational status of the multi-device wireless charger that includes a vehicle 502D, detected connection status 504D, detected charging status 506D, and a notification panel 508D. It should be noted that the exemplary scenario 500D of FIG. 5D is for exemplary purposes and should not be construed to limit the scope of the disclosure

The vehicle 502D may be similar to the vehicle 502A of FIG. 5A and the vehicle 114 of FIG. 1. The detected connection status 504D may be similar to the detected connection status 504A of FIG. 5A, and the detected charging status 506D may be similar to the detected charging status of 506D. Hence, details of the vehicle 502D, detected connection status 504D, and detected charging status of 506D are omitted herein for the sake of brevity.

In an example, the hardware failure associated with at least one charging system of the plurality of charging systems 108 of the multi-device wireless charger 104 may be detected, based on the detected connection status and charging status. Further, a foreign object on a surface or in a proximity of at least one of the charging systems 108 may be detected by the first electronic device 102. Foreign objects may include, for example, items which interfere with the magnetic field of the multi-device wireless charger 104. The items may correspond, but are not limited to, metal coins, keys, credit cards, metal phone cases, or any other object which may interfere with the magnetic field of the multi-device wireless charger 104. Based on the detected connection status, the detected charging status, the detected hardware failure, and/or the detected foreign object, the operational status of the multi-device wireless charger 104 may be determined. Thereafter, based on the determined operational status of the multi-device wireless charger 104, the UI element 118 may be rendered on the display device. In an example, the notification panel 508D may be configured to render a set of icons associated with at least one of the detected connection status, the detected charging status, the detected hardware failure, or the detected foreign object.

For example, herein, the notification panel 508D may display the UI element in form of a fourth icon associated with a foreign object detected on at least one of the charging systems of the multi-device wireless charger 104. The fourth icon may indicate the determined operational status as a fourth status corresponding to the steady state charging associated with the first device of the plurality of second electronic devices 106 and the detection of a foreign object with the charging system associated with the second device of the plurality of second electronic devices 106. In an example, the fourth icon may indicate a foreign object detection symbol, such as a slash mark in the center of the fourth icon, and blinking with respect to the detected foreign object in the charging system associated with the second device designated by the numeral “2” blinking (or the numeral “2”may change font type, color, etc.).

The foreign object detection symbol (e.g., the slash mark) denotes detection of the foreign object in at least one of the charging systems of the multi-device wireless charger. The charging system associated with the second device blinks (or may change font type, color, etc.) to notify the user of the location of the detected foreign object, while the charging system associated with the first device does not change due to operating normally. Additionally, the user may be notified that the foreign object is present in the charging system associated with the second device. For example, based on a user interaction with the fourth icon (e.g., user taps the fourth icon through the I/O device 208), a notification center may be displayed for the user. The notification center may include a message of the foreign object detected with the charging system associated with the second device.

FIG. 5E is a block diagram that illustrates an exemplary scenario for UI element-based display of the operational status of the multi-device wireless charger installed in the vehicle, in accordance with a fifth embodiment of the disclosure. FIG. 5E is explained in conjunction with elements from FIGS. 1-4 and 5A-5D. With reference to FIG. 5E, there is shown an exemplary scenario 500E for the UI element-based display of the operational status of the multi-device wireless charger that includes a vehicle 502E, detected connection status 504E, detected charging status 506E, and a notification panel 508E. It should be noted that the exemplary scenario 500E of FIG. 5E is for exemplary purposes and should not be construed to limit the scope of the disclosure

The vehicle 502E may be similar to the vehicle 502A of FIG. 5A and the vehicle 114 of FIG. 1. The detected connection status 504E may be similar to the detected connection status 504A of FIG. 5A, and the detected charging status 506E may be similar to the detected charging status of 506A. Hence, details of the vehicle 502E, detected connection status 504E, and detecting charging status 506E are omitted herein for the sake of brevity.

In an example, the hardware failure associated with at least one charging system of the plurality of charging systems 108 of the multi-device wireless charger 104 may be detected, based on the detected connection status and charging status. Further, a foreign object on a surface or in proximity of at least one the charging systems 108 may be detected by the first electronic device 102. Based on the detected connection status, charging status, detected hardware failure, and/or the detected foreign object, the operational status of the multi-device wireless charger 104 may be determined. Thereafter, based on the determined operational status of the multi-device wireless charger 104, the UI element 118 may be rendered on the display device. In an example, the notification panel 508E may be configured to render a set of icons associated with at least one of the detected connection status, the detected charging status, the detected hardware failure, or the detected foreign object.

For example, herein, the notification panel 508E may display the UI element in form of a fifth icon associated with a foreign object detected with each of the charging systems of the multi-device wireless charger 104. The fifth icon may indicate the determined operational status as a fifth status corresponding to the detection of the foreign object associated with each charging system of the plurality of charging systems 108 of the multi-device wireless charger 104. In an example, the fifth icon may indicate the foreign object detection symbol (e.g., the slash mark) and blinking with respect to the detected foreign object in the charging systems associated with the first device and the second device which may be designated as numeral “1” blinking and numeral “2” blinking (or the numerals “1” and “2” may change font type, color, etc.). Additionally, the user may be notified that the foreign object is present in the charging systems of both the first device and the second device. For example, based on a user interaction with the fifth icon (e.g., user taps the fifth icon through the I/O device 208), a notification center may be displayed for the user. The notification center may include a message of the foreign object detected in the charging systems of both the first device and the second device.

FIG. 5F is a block diagram that illustrates an exemplary scenario for UI element-based display of the operational status of the multi-device wireless charger installed in the vehicle, in accordance with a sixth embodiment of the disclosure. FIG. 5F is explained in conjunction with elements from FIGS. 1-4 and 5A-5E. With reference to FIG. 5F, there is shown an exemplary scenario 500F for the UI element-based display of the operational status of the multi-device wireless charger 104. The exemplary scenario 500F includes a vehicle 502F, detected connection status 504F, detected charging status 506F, and a notification panel 508F. It should be noted that the exemplary scenario 500F of FIG. 5F is for exemplary purposes and should not be construed to limit the scope of the disclosure

The vehicle 502F may be similar to the vehicle 502A of FIG. 5A and the vehicle 114 of FIG. 1. The detected connection status 504F may be similar to the detected connection status 504A of FIG. 5A, and the detected charging status 506F may be similar to the detected charging status of 506A. Hence, details of the vehicle 502F, detected connection status 504F, and detected charging status 506F are omitted herein for the sake of brevity.

In an example, the hardware failure associated with at least one charging system of the plurality of charging systems 108 of the multi-device wireless charger 104 may be detected, based on the detected connection status and the detected charging status. Further, a foreign object on a surface or in a proximity of at least one of the charging systems 108 may be detected by the first electronic device 102. Based on the detected connection status, the detected charging status, the detected hardware failure, and/or the detected foreign object, the operational status of the multi-device wireless charger 104 may be determined. Thereafter, based on the determined operational status of the multi-device wireless charger 104, the UI element 118 may be rendered on the display. In an example, the notification panel 508F may be configured to render a set of icons associated with at least one of the detected connection status, the detected charging status, the detected hardware failure, or the detected foreign object.

For example, herein, the notification panel 508F may display the UI element in form of a sixth icon associated with the detection of a foreign object and a detection of a hardware failure on the charging systems of the multi-device wireless charger 104. The sixth icon may indicate the determined operational status as a sixth status corresponding to the detection of the foreign object in the charging associated with the first device of the plurality of second electronic devices 106 and the detection of the hardware failure in charging of the second device of the plurality of second electronic devices 106.

Further, as a result of the above determined operational status as the sixth status, the first electronic device 102 may also determine a priority between the detected foreign object in the charging system associated with the first device and the detected the hardware failure in the charging system associated with the second device. For example, in the exemplary sixth status, a higher priority may be assigned to the hardware failure detection in the charging of the second device and a lower priority may be assigned to the foreign object detection in the charging of the first device. The assigned priority may be represented by the sixth icon, which may indicate the hardware failure detection symbol (e.g., the exclamation mark), and blinking with respect to the detected hardware failure in the charging system associated with the second device designated by “2” blinking per higher priority (or the numeral “2” may change font type, color, etc.). The charging system associated with the second device blinks (or may change font type, color, etc.) to notify the user of the location of the detected hardware failure.

In other embodiments, the charging system associated with the second device is assigned the first or higher priority, and the numeral “2” starts blinking first, thereby indicating the charging system associated with the second device has a hardware failure and is assigned a higher priority. Further, during the display of the sixth icon, the numeral “1” may blink after the blinking of the numeral “2”, which indicates that the charging system associated with the first device has a detected foreign object and is assigned lower priority. Additionally, or alternatively, the sixth icon may indicate both the foreign object detection symbol and the hardware failure detection symbol and/or the numerals “1” and “2” may blink at different rates or change different colors or fonts upon detection of the foreign object associated with the charging system of the first device and detection of the hardware failure associated with the charging system of the second device.

Furthermore, based on the priority, the user may be notified that the hardware failure is present in the charging system the second device. For example, based on a user interaction with the sixth icon (e.g., the user taps the sixth icon through the I/O device 208), a notification center may be displayed for the user. The notification center may include a message of the hardware failure detected in the charging system of the second device. In other aspects, the notification center may include a message of the hardware failure detected in the charging system of the second device and of the foreign object detected in the charging system of the first device.

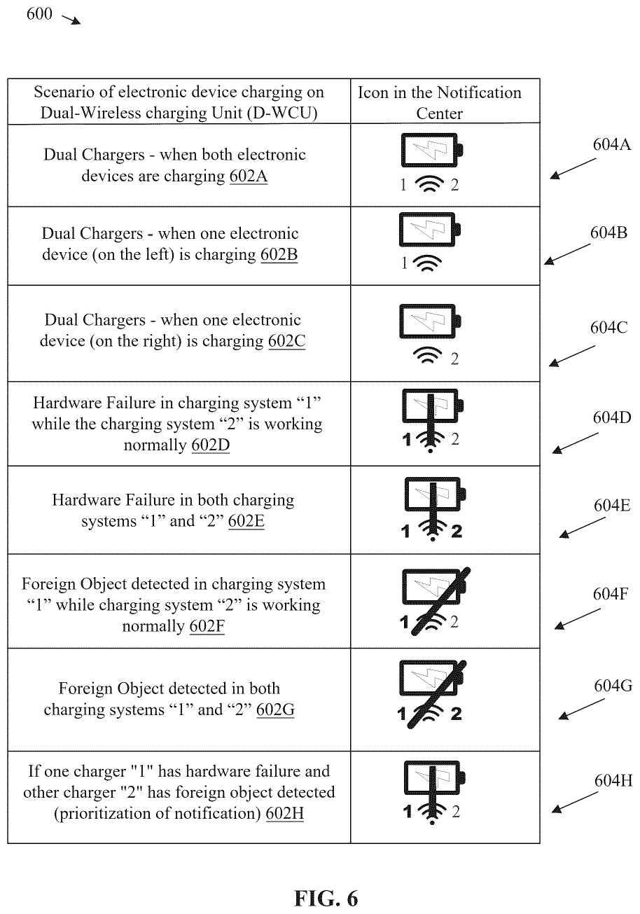

FIG. 6 is a table that illustrates different UI elements displayed corresponding to different scenarios of the operational status of the multi-device wireless charger, in accordance with an embodiment of the disclosure. FIG. 6 is explained in conjunction with elements from FIGS. 1-4 and 5A-5F. With reference to FIG. 6, there is shown a table 600 including different scenarios related to charging of one electronic device (e.g., the first device) on a first side (e.g., a left side) and another electronic device (e.g., the second device) on a second side (e.g., a right side) opposite to the first side of a dual wireless charging unit (e.g., the multi-device wireless charger 104). The table 600 includes different scenarios of operational statuses of the multi-device wireless charger 104 and corresponding UI elements that may be displayed in the notification panel 508A.

At 602A, 602B, and 602C, the operational status may be a first status corresponding to the steady-state charging associated with each connected second electronic device that is charging when the corresponding charging systems 108 of the multi-device wireless charger 104 are operating normally. Based on the operational status being the first status, a first UI element may be displayed, which indicates each second electronic device that is charging when the charging systems are operating normally. For example, at 602A, both second electronic devices (the first device on the left and second device on the right of the multi-device wireless charger 104) are charging, and the first UI element 604A indicates both a numeral “1” for the first device charging and a numeral “2” for the second device charging. Further, at 602B and 602C, the steady state charging is associated with only one second electronic device that is charging and the other second electronic device is not charging. For example, the first UI element 604B indicates only a numeral “1” for when the first device is charging, and the first UI element 604C indicates only a numeral “2”when the second device is charging.

At 602D, the operational status may be determined as a second status corresponding to a hardware failure in at least one charging system associated with one second electronic device and steady state charging associated with another second electronic device. In such a case, a second UI element 604D may displayed based on the operational status being the second status. For example, the second UI element 604D indicates a detected hardware failure with a hardware failure detection symbol (e.g., an exclamation mark) and the associated charging system with a bolded numeral “1” indicates the location of the detected hardware failure. Further, at 602E, the operational status may be determined as a third status corresponding to the hardware failure detected in the charging systems associated with each of the second electronic devices. In such a case, a third UI element 604E may be displayed based on the operational status being the third status. For example, the third UI element 604E indicates the detected hardware failure with the hardware failure detection symbol (e.g., the exclamation mark) and both charging systems with a bolded numeral “1” and a bolded numeral “2” indicates the locations of the detected hardware failure.

At 602F, the operational status may be determined as a fourth status corresponding to the detection of the foreign object in at least one charging system associated with one second electronic device and the steady state charging associated with another second electronic device. In such a case, a fourth UI element 604F may be displayed based on the operational status being the fourth status. For example, the fourth UI element 604F indicates a detected foreign object with a foreign object detection symbol (e.g., a slash mark) and the associated charging system with a bolded numeral “1” indicates the location of the detected foreign object. Further, at 602G, the operational status may be determined as a fifth status corresponding to the detection of the foreign object in the charging systems associated with each of the second electronic devices. In such a cased, a fifth UI element 604G may be displayed based on the operational status being the fifth status. For example, the fifth UI element 604G indicates the detected foreign object with the foreign object detection symbol (e.g., slash mark) and both charging systems with a bolded numeral “1” and a bolded numeral “2” indicates the locations of the detected foreign object.

At 602H, the operational status may be determined as sixth status corresponding to the hardware failure detected in one second electronic device, and the detection of the foreign object in the charging associated with another second electronic device. In such a case, a sixth UI element 604H may be displayed based on the operational status being the sixth status and a determined priority. For example, the sixth UI element 604H indicates a priority of the detected hardware failure over the detected foreign object, by displaying the hardware failure detection symbol (e.g., the exclamation mark) and associated charging system with a bolded numeral “1” indicates the location of the detected hardware failure.

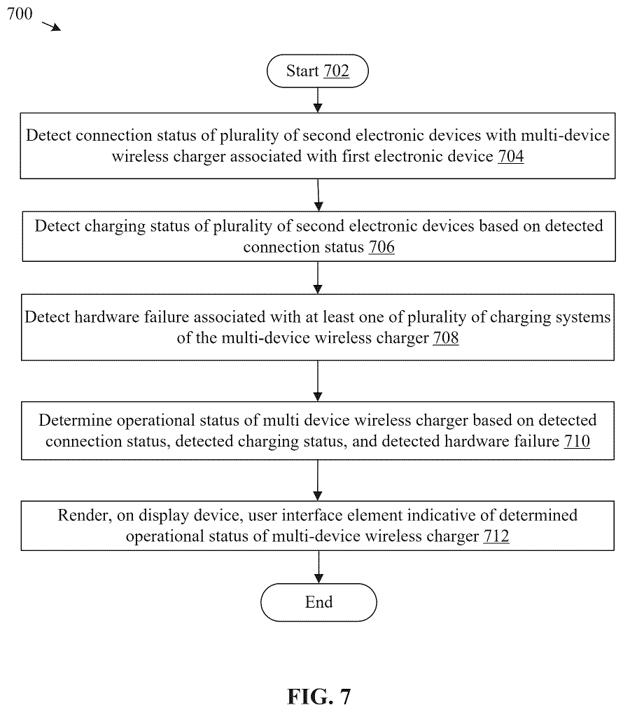

FIG. 7 is a flowchart that illustrates exemplary operations of a method for UI element-based display of the operational status of the multi-device wireless charger, in accordance with an embodiment of the disclosure. With reference to FIG. 7, there is shown a flowchart 700. The flowchart 700 is described in conjunction with FIGS. 1-4, 5A-5F, and 6. The operations from 702 to 712 may be implemented, for example, by the circuitry 202 of the first electronic device 102 of FIG. 2. The operations of the flowchart 700 may start at 702 and proceed to 704.

At 704, the connection status of the plurality of second electronic devices 106 with the multi-device wireless charger 104 may be detected. The circuitry 202 may be configured to detect the connection status of the plurality of second electronic devices 106 with the multi-device wireless charger 104. The multi-device wireless charger 104 may be configured to charge the multiple devices concurrently and may include the plurality of charging systems 108. In an embodiment, the detected connection status may indicate the connection status data that may be detected upon the wireless connection of the plurality of second electronic devices 106 with the multi-device wireless charger 104. Details related to the detection of the connection status of the plurality of second electronic devices 106 with the multi-device wireless charger 104 are provided, for example, in FIG. 4 (at 402).

At 706, the charging status of the plurality of second electronic devices 106 may be detected, based on the detected connection status. The circuitry 202 may be configured to detect the charging status of the plurality of second electronic device 106, based on the detected connection status. In an embodiment, the detected charging status may indicate the charging status data that may be detected based on the connection status of the plurality of second electronic devices 106 with the multi-device wireless charger 104. Further, the detected charging status may indicate, but is not limited to, a state of charge (SOC) of the battery which provides information associated with an amount of charge that may be available in the battery at a time instant. Details related to the detection of the charging status are provided, for example, in FIG. 4 (at 404).

At 708, the hardware failure associated with the at least one of the plurality of charging systems 108 of the multi-device wireless charger 104 may be detected, based on the detected connection status and charging status. The circuitry 202 may be configured to detect the hardware failure associated with the at least one of the plurality of charging systems 108 of the multi-device wireless charger 104, based on the detected connection status and charging status. The detected hardware failure may correspond, for example, to at least one of a thermistor failure, a fan failure, an internal temperature failure, a Direct Current (DC)-DC failure, or a power supply failure. Details related to the detection of the hardware fault or failure are provided, for example, in FIG. 4 (at 406).

At 710, the operational status of the multi-device wireless charger 104 may be determined based on the detected connection status, charging status, and hardware failure. The circuitry 202 may be configured to determine the operational status of the multi-device wireless charger 104, based on the detected connection status, charging status, and hardware failure. The determined operational status may be a first status corresponding to a steady state associated with each electronic device of the plurality of second electronic devices 106. The determined operational status also may be a second status corresponding to the steady state charging associated with a first device of the plurality of second electronic devices 106, and the detection of the hardware failure in charging of a second device of the plurality of second electronic devices 106. Further, the determined operational status may be a third status corresponding to the detection of the hardware failure in charging of each electronic device of the plurality of second electronic devices 106. Details related to the determination of the operational status are provided, for example, in FIG. 4 (at 408).

At 712, the UI element 118 may be rendered on the display device 206A associated with the first electronic device 102. The rendered UI element 118 may be indicative of the determined operational status of the multi-device wireless charger 104. The circuitry 202 may be configured to render the UI element 118 on the display device 206A associated with the first electronic device 102. The UI element 118 may include a first icon based on the determined operational status being the first status. The UI element 118 may include a second icon based on the determined operational status being the second status. The UI element 118 may include a third icon based on the determined operational status being the third status. Details related to the rendering of the UI element are provided, for example, in FIG. 4 (at 410). Control may pass to end.

Although the flowchart 700 is illustrated as discrete operations, such as 704, 706, 708, 710, and 712, the disclosure is not so limited. Accordingly, in certain embodiments, such discrete operations may be further divided into additional operations, combined into fewer operations, or eliminated, depending on the particular implementation without detracting from the essence of the disclosed embodiments.

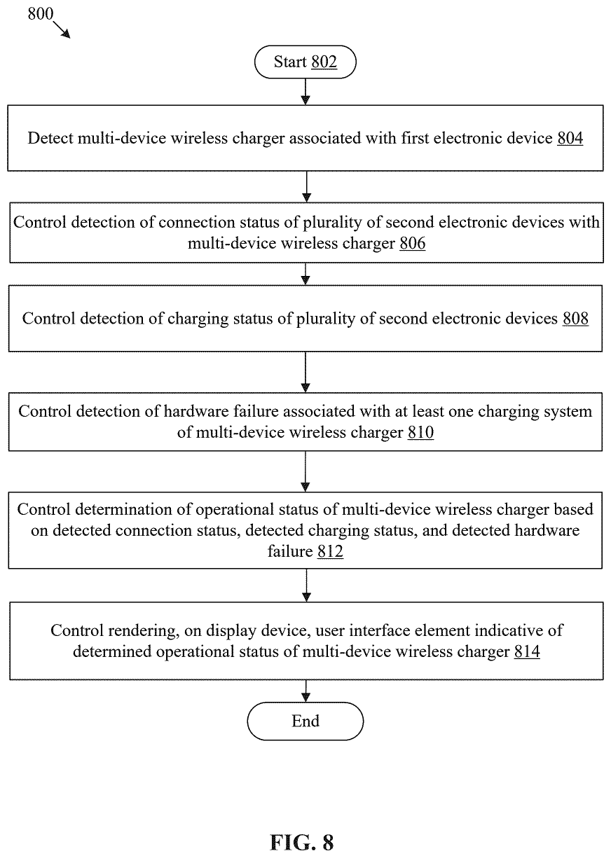

FIG. 8 is a flowchart that illustrates exemplary operations of a method for UI element-based display of the operational status of the multi-device wireless charger installed in a vehicle, in accordance with an embodiment of the disclosure. With reference to FIG. 8, there is shown a flowchart 800. The flowchart 800 is described in conjunction with FIGS. 1-4, 5A-5F, and 6. The operations from 802 to 814 may be implemented, for example, by the circuitry 202 of the first electronic device 102 of FIG. 2 or the ECU 304 of the vehicle 114 of FIG. 3. The operations of the flowchart 800 may start at 802 and proceed to 814.

At 804, the multi-device wireless charger 104 associated with the first electronic device 102 may be detected. The ECU 304 may be configured to detect the multi-device wireless charger 104. The multi-device wireless charger 104 may be configured to charge the multiple devices concurrently and may include the plurality of charging systems 108. In an embodiment, the ECU 304 may detect a wired or wireless connection status of the multi-device wireless charger 104 with the vehicle 114. Based on a detection that the multi-device wireless charger 104 is connected with the vehicle 114, the ECU 304 may detect the multi-device wireless charger 104.

At 806, the detection of the connection status of the plurality of second electronic devices 106 with the multi-device wireless charger 104 may be controlled, based on the detection of the multi-device wireless charger 104. The ECU 304 may be configured to control the detection of the connection status of the plurality of second electronic devices 106 with the multi-device wireless charger 104, based on the detection of the multi-device wireless charger 104. In an embodiment, if the multi-device wireless charger 104 is detected as connected with the vehicle 114, the ECU 304 may control the first electronic device 102 or the multi-device wireless charger 104 to detect the connection status of the plurality of second electronic devices 106. The detection of the connection status is described further, for example, in FIG. 4 (at 402).

At 808, the detection of the charging status of the plurality of second electronic devices 106 may be controlled, based on the detection of the connection status of the plurality of second electronic devices 106 with the multi-device wireless charger 104. The ECU 304 may be configured to control the detection of the charging status of the plurality of second electronic devices 106, based on the detection of the charging status of the plurality of second electronic devices 106. For example, if the plurality of second electronic devices 106 are detected as wirelessly connected with the multi-device wireless charger 104, the ECU 304 may control the detection of the charging status of the plurality of second electronic devices 106 (based on, for example, a flow of current to the plurality of second electronic devices 106). The detection of the charging status is described further, for example, in FIG. 4 (at 404).

At 810, the detection of the hardware failure associated with the at least one of the plurality of charging systems 108 of the multi-device wireless charger 104 may be controlled, based on the detection of the connection status and the charging status. The ECU 304 may be configured to control the detection of the hardware failure associated with the at least one of the plurality of charging systems 108 of the multi-device wireless charger 104, based on the detection of the connection status and the charging status. The first electronic device 102 may detect the hardware failure and transmit the hardware failure data to the ECU 304. The detection of the hardware fault or failure is described further, for example, in FIG. 4 (at 406).

At 812, the determination of the operational status of the multi-device wireless charger 104 may be controlled, based on the detection of the connection status, the charging status, and the hardware failure. The ECU 304 may be configured to control the determination of the operational status of the multi-device wireless charger 104, based on the detection of the connection status, the charging status, and the hardware failure. In an embodiment, the ECU 304 may retrieve information about different scenarios of the connection status, the charging status, and the hardware failure from a lookup table. The lookup table may be either stored on a memory associated with the ECU 304, the memory 204 of the first electronic device 102, or the database 112. Based on the retrieved information, the ECU 304 may control the determination of the operational status. Alternatively, the first electronic device 102 may determine the operational status and transmit the operational status data to the ECU 304. The determination of the operational status is described further, for example, in FIG. 4 (at 408).

At 814, rendering of the UI element 118, on the display device 206A associated with the first electronic device 102 may be controlled. The rendered UI element 118 may be indicative of the operational status of the multi-device wireless charger 104. The ECU 304 may be configured to control the rendering of the UI element 118 on the display device 206A associated with the first electronic device 102. The UI element 118 may include a first icon based on the determined operational status being the first status; a second icon based on the determined operational status being the second status, and a third icon based on the determined operational status being the third status. Details related to the rendering of the UI element are provided, for example, in FIG. 4 (at 410). Control may pass to end.

Although the flowchart 800 is illustrated as discrete operations, such as 804, 806, 808, 810, 812, and 814, the disclosure is not so limited. Accordingly, in certain embodiments, such discrete operations may be further divided into additional operations, combined into fewer operations, or eliminated, depending on the particular implementation without detracting from the essence of the disclosed embodiments.

Various embodiments of the disclosure may provide a non-transitory, computer-readable medium and/or storage medium, and/or a non-transitory machine readable medium and/or storage medium stored thereon, a set of instructions executable by a machine and/or a computer (such as the circuitry 202). The instructions may cause the machine and/or computer (for example, the first electronic device 102) to perform operations that may include detecting the connection status of the plurality of second electronic devices 106 with the multi-device wireless charger 104 associated with the first electronic device 102. The operations may further include detecting the charging status of the plurality of second electronic devices 106, based on the detected connection status. The operations may further include detecting the hardware failure associated with the at least one the plurality of charging systems 108 of the multi-device wireless charger 104, based on the detected connection status and the detected charging status. The operations may further include determining the operational status of the multi-device wireless charger 104 based on the detected connection status, the detected charging status, and the detected hardware failure. The operations may further include rendering, on the display device 208A associated with the first electronic device 102, the UI element 118 indicative of the determined operational status of the multi-device wireless charger 104.

Various embodiments of the disclosure may provide a non-transitory, computer-readable medium and/or storage medium, and/or a non-transitory machine readable medium and/or storage medium stored thereon, a set of instructions executable by a machine and/or a computer (such as the circuitry 202 of the first electronic device 102). The instructions may cause the machine and/or computer (for example, the electronic control unit (ECU) 304 of the vehicle 114) to perform operations that include detecting the multi-device wireless charger 104 associated with the first electronic device 102. The operations may further include controlling detection of the connection status of the plurality of second electronic devices 106 with the multi-device wireless charger 104, based on the detection of the multi-device wireless charger 104. The operations may further include controlling detection of the charging status of the plurality of second electronic devices 106, based on the control of the detection of the connection status of the plurality of second electronic devices 106 with the multi-device wireless charger 104. The operations may further include controlling detection of the hardware failure associated with the at least one of the plurality of charging systems 108 of the multi-device wireless charger 104, based on the control of the detection of the connection status and the charging status. The operations may further include controlling of the determination of the operational status of the multi-device wireless charger 104, based on the control of the detection of the connection status, the charging status, and the hardware failure. The operations may further include controlling of the rendering, on the display device 208A associated with the first electronic device 102, of the UI element 118 indicative of the operational status of the multi-device wireless charger 104.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that includes a portion of an integrated circuit that also performs other functions. It may be understood that, depending on the embodiment, some of the steps described above may be eliminated, while other additional steps may be added, and the sequence of steps may be changed.

The present disclosure may also be embedded in a computer program product, which includes all the features that enable the implementation of the methods described herein, and which when loaded in a computer system may be able to carry out these methods. Computer program, in the present context, means any expression, in any language, code or notation, of a set of instructions intended to cause a system with an information processing capability to perform a particular function either directly, or after either or both of the following: a) conversion to another language, code or notation; b) reproduction in a different material form. While the present disclosure has been described with reference to certain embodiments, it will be understood by those skilled in the art that various changes may be made, and equivalents may be substituted without departing from the scope of the present disclosure. In addition, many modifications may be made to adapt a particular situation or material to the teachings of the present disclosure without departing from its scope. Therefore, it may be intended that the present disclosure may be not limited to the particular embodiment disclosed, but that the present disclosure will include all embodiments that fall within the scope of the appended claims.

What is claimed is:

1. A first electronic device comprising:
circuitry configured to:
detect a connection status of a plurality of second electronic devices with a multi-device wireless charger, the multi-device wireless charger being configured to charge the plurality of second electronic devices concurrently using a plurality of charging systems, and the connection status being a status indicating a wireless connection of the plurality of second electronic devices with the multi-device wireless charger;
detect a charging status of the plurality of second electronic devices, based on the detected connection status;
detect a hardware failure associated with at least one of the plurality of charging systems of the multi-device wireless charger, based on the detected connection status and charging status;
determine an operational status of the multi-device wireless charger based on the detected connection status, charging status, and hardware failure; and
render, on a display device associated with the first electronic device, a user interface (UI) element indicative of the determined operational status of the multi-device wireless charger, wherein the UI element comprises an icon indicating the determined operational status of the multi-device wireless charger.

2. The first electronic device according to claim 1, wherein the determined operational status being a first status corresponding to a steady state charging associated with each electronic device of the plurality of second electronic devices that is charging when the plurality of charging systems are operating normally, and the UI element includes a first icon based on the determined operational status being the first status.

3. The first electronic device according to claim 1, wherein the determined operational status being a second status corresponding to a steady state charging associated with a first device of the plurality of second electronic devices and the detection of the hardware failure in a charging system associated with a second device of the plurality of second electronic devices, and the UI element includes a second icon based on the determined operational status being the second status.

4. The first electronic device according to claim 1, wherein the determined operational status being a third status corresponding to the detection of the hardware failure in charging systems associated with of each electronic device of the plurality of second electronic devices, and the UI element includes a third icon based on the determined operational status being the third status.

5. The first electronic device according to claim 1, wherein the detected hardware failure corresponds to at least one of a thermistor failure, a fan failure, an internal temperature failure, a Direct Current (DC)-DC failure, or a power supply failure.

6. The first electronic device according to claim 1, wherein the circuitry is further configured to: detect a foreign object associated with at least one of the plurality of charging systems of the multi-device wireless charger, based on the detected connection status and the detected charging status, wherein the foreign object is an object other than a device in the plurality of second electronic devices.

7. The first electronic device according to claim 6, wherein the circuitry is further configured to: render, on the display device, a notification panel including a set of icons associated with at least one of the detected connection status, charging status, hardware failure, or foreign object.

8. The first electronic device according to claim 6, wherein the detected foreign object corresponds to at least one of a partial power transfer to a thermistor or a partial power supply to the plurality of charging systems of the multi-device wireless charger, or objects which interfere with magnetic field of the multi-device wireless charger.

9. The first electronic device according to claim 6, wherein the determined operational status being a fourth status corresponding to the steady state charging associated with a first device of the plurality of second electronic devices and the detection of the foreign object in a charging system associated with a second device of the plurality of second electronic devices, and the UI element includes a fourth icon corresponding to the determined operational status being the fourth status.

10. The first electronic device according to claim 6, wherein the determined operational status being a fifth status corresponding to the detection of the foreign object associated with each charging system of the plurality of charging systems of the multi-device wireless charger, and the UI element includes a fifth icon corresponding to the determined operational status being the fifth status.

11. The first electronic device according to claim 6, wherein the determined operational status being a sixth status corresponding to the detection of the foreign object in a charging system associated with a first device of the plurality of second electronic devices and the detection of the hardware failure in a charging system associated with a second device of the plurality of second electronic devices, and the UI element includes a sixth icon corresponding to the determined operational status being the sixth status.

12. The first electronic device according to claim 11, wherein the circuitry is further configured to: determine a priority associated with the sixth status corresponding to the detection of the foreign object in the charging system associated with the first device and the detection of the hardware failure in charging system of the second device, wherein the UI element corresponds to the determined operational status being the sixth status based on the determined priority.

13. A vehicle, comprising:
an electronic control unit (ECU) configured to:
detect a multi-device wireless charger associated with a first electronic device, the multi-device wireless charger being configured to charge multiple electronic devices concurrently using a plurality of charging systems;
control, based on the detection of the multi-device wireless charger, detection of a connection status of a plurality of second electronic devices with the multi-device wireless charger, the connection status being a status indicating a wireless connection of the plurality of second electronic devices with the multi-device wireless charger;
control, based on the detection of the connection status, detection of a charging status of the plurality of second electronic devices;
control, based on the detection of the connection status and the charging status, detection of a hardware failure associated with at least one of the plurality of charging systems of the multi-device wireless charger;
control determination of an operational status of the multi-device wireless charger based on the detection of the connection status, the charging status, and the hardware failure; and
control rendering, on a display device, a user interface (UI) element indicative of the operational status of the multi-device wireless charger.

14. The vehicle according to claim 13, wherein the determined operational status being a second status corresponding to a steady state charging associated with a first device of the plurality of second electronic devices and the detection of the hardware failure in a charging system associated with a second device of the plurality of second electronic devices, and the UI element includes a second icon based on the determined operational status being the second status.

15. The vehicle according to claim 13, wherein the ECU is further configured to detect a foreign object associated with at least one of the plurality of charging systems of the multi-device wireless charger, based on the detection of the connection status and the charging status, wherein the foreign object is an object other than a device in the plurality of second electronic devices.

16. The vehicle according to claim 15, wherein the determined operational status being a fourth status corresponding to the steady state charging associated with a first device of the plurality of second electronic devices and the detection of the foreign object in a charging associated with a second device of the plurality of second electronic devices, and the UI element includes a fourth icon corresponding to the determined operational status being the fourth status.

17. The vehicle according to claim 15, wherein the determined operational status being a fifth status corresponding to the detection of the foreign object associated with each charging system of the plurality of charging systems of the multi-device wireless charger, and the UI element includes a fifth icon corresponding to the determined operational status being the fifth status.

18. The vehicle according to claim 15, wherein the determined operational status being a sixth status corresponding to the detection of the foreign object in the charging associated with a first device of the plurality of second electronic devices and the detection of the hardware failure in charging of a second device of the plurality of second electronic devices, and the UI element includes a sixth icon corresponding to the determined operational status being the sixth status.

19. The vehicle according to claim 18, wherein the ECU is further configured to:
determine a priority associated with the sixth status corresponding to the detection of the foreign object in the charging associated with the first device and the detection of the hardware failure in charging of the second device, wherein the UI element corresponds to the determined operational status being the sixth status based on the determined priority.

20. A method, comprising:
in a first electronic device:
detecting a connection status of a plurality of second electronic devices with a multi-device wireless charger, the multi-device wireless charger being configured to charge multiple electronic devices concurrently using a plurality of charging systems, and the connection status being a status indicating a wireless connection of the plurality of second electronic devices with the multi-device wireless charger;
detecting a charging status of the plurality of second electronic devices, based on the detected connection status;
detecting a hardware failure associated with at least one of the plurality of charging systems of the multi-device wireless charger, based on the detected connection status and the detected charging status;
determining an operational status of the multi-device wireless charger based on the detected connection status, the detected charging status, and the detected hardware failure; and
rendering, on a display device associated with the first electronic device, a user interface (UI) element indicative of the determined operational status of the multi-device wireless charger.
